(19) United States
(12) Patent Application Publication
(10) Pub. No.: US 2009/0109473 A1
(43) Pub. Date: Apr. 30, 2009

(54) INFORMATION PROCESSING DEVICE, INFORMATION PROCESSING METHOD, AND COMPUTER-READABLE STORAGE MEDIUM

(75) Inventor: Hisashi Kato, Yokohama-shi (JP)

Correspondence Address: CANON U.S.A. INC. INTELLECTUAL PROPERTY DIVISION, 15975 ALTON PARKWAY, IRVINE, CA, 92618-3731, US

(73) Assignee: CANON KABUSHIKI KAISHA, Tokyo (JP)

(21) Appl. No.: 12/255,489

(22) Filed: Oct. 21, 2008

(30) Foreign Application Priority Data
Oct. 25, 2007 (JP) 2007-277906

(51) Int. Cl. G06F 3/12

(52) U.S. Cl. 358/1.15

(57) ABSTRACT

An application obtains printer capability information from a printer driver. Subsequently, the application obtains the text string information corresponding to a function based on the printer capability information obtained from the printer driver. Subsequently, the application performs instructions for displaying the characters of the function displayed on a printer driver screen using the characters of the obtained text string information.

### BACKGROUND OF THE INVENTION

1. Field of the Invention

The present invention relates to information processing of an information processing device for controlling a user interface for performing printing settings.

2. Description of the Related Art

With Microsoft Windows (registered trademark) Vista which is an operating system (OS) of Microsoft Corporation, the printing system has been modified greatly. An XPS (XML Paper Specification)—based new printing system has been introduced, whereby a GDI (Graphic Device Interface)—based printing system according to the related art can be replaced therewith (see http://www.microsoft.com/japan/whde/device/print/default.msp x). XPS is one of electronic document formats, and the content thereof is made up of XML holding information such as a document structure, drawing information, printing settings, and so forth, and various parts such as binary sources such as a bitmap, font, and so forth.

Particular important parts making up the XPS are shown in FIG. 28. FIG. 28 is a diagram for describing the structure of an electronic document format which can be processed by an information processing device. In FIG. 28, a structure example is illustrated wherein one electronic document always includes a FixedDocumentSequence part so as to correspond to a job, which includes FixedDocument1 through FixedDocumentN parts so as to correspond to each document, and further the FixedDocument1 through FixedDocumentN parts include FixedPage1 through FixedPageN parts so as to correspond to each document.

Further, these arbitrary FixedDocumentSequence part, FixedDocument part, and FixedPage part can each be correlated with printing settings, as shown in FIG. 29. FIG. 29 is a diagram illustrating an example printing settings which can be correlated with each part of the electronic document shown in FIG. 28. As shown in FIG. 29, printing settings which can be correlated with each part of an electronic document will be referred to as a print ticket.

Now, printing settings correlated with a FixedDocumentSequence part will be referred to as a job-level print ticket. Also, printing settings correlated with a FixedDocument part will be referred to as a document-level print ticket. Further, printing settings correlated with a FixedPage part will be referred to as a page-level print ticket. Note that, with a job-level print ticket, printing settings of a job is performed. With a document-level print ticket, printing settings of a document is performed. With a page-level print ticket, printing settings of a page is performed.

Next, description will be made regarding a printing setting format, and a printer driver interface, of the related art. With the printing system of Microsoft Windows (registered trademark) of the related art, a memory block called DEVMODE used by a Win32 application has served an important role as printing setting data.

FIG. 30 is a diagram for describing a memory block according to a printing system of the related art. The present example illustrates the entire image of the DEVMODE used by a Win32 application in a simplified manner. The features of a DEVMODE structure are in that this structure is made up of two areas of a public portion 301 of which the specification has been disclosed, and a private portion 302 of which the specification has not been disclosed which can be accessed by a printer driver alone. In general, with the public portion 301 of a DEVMODE structure, only basic portions such as sheets, orientation of sheets, resolution, and so forth are described, and all of the remaining portions occupying a majority portion are described in the private portion 302.

FIG. 31 is a diagram illustrating an example of the DEVMODE public portion 301 shown in FIG. 30. As shown in FIG. 31, a DEVMODE structure is strictly stipulated as a header file of C language by Microsoft Corporation. It can be seen that the DEVMODE public portion 301 has no concept of scope. On the other hand, the private portion 302 defined individually by each company for developing a printer driver follows immediately after this structure, and the extended size thereof is specified with dmDriverExtra. A print ticket introduced from Microsoft Windows (registered trademark) Vista is a new format alternative to such a legacy printing setting format.

To summarize the above description, the DEVMODE, which is a format of the related art, has features as in the following (1) through (4).
(1) Described with a structure. The specification of the private portion occupying a majority portion has not been disclosed.
(2) Made up of binary having no readability.
(3) Accessible only by a printer driver.
(4) Having no scope concept regarding each of printing settings.

On the other hand, a print ticket serving as a new format is described with XML, and has features as in the following (5) through (8).
(5) Specification has been disclosed.
(6) Made up of text having readability.
(7) Accessible to an application and so forth as well as a printer driver.
(8) A scope is specified to each of printing settings.

Thus, with a print ticket, functions are greatly enhanced as compared to the DEVMODE.

With a printing system according to the related art, DeviceCapabilities API has been prepared for an application obtaining device capability information. An application employs the DeviceCapabilities API to obtain available sheet size information, duplex printing capability information, and so forth of a device, and build up a printing screen of the application. With the DeviceCapabilities API, particular function information defined with a Windows (registered trademark) system can be obtained, but there is a problem wherein no capability information other than the particular function information can be obtained.

On the other hand, with Windows (registered trademark) Vista, device capability information of an XML format called PrintCapabilities is introduced as an arrangement alternative to the DeviceCapabilities.

FIG. 32 is a diagram illustrating an example of the PrintCapabilities which a printer driver to be installed in an information processing device returns to an application. In FIG. 32, multiple Feature tags 1302 indicating functions are provided within one PrintCapabilities tag 1301. Further, multiple Option tags 1304 within the Feature tags 1302 become function setting item candidates.

With the PrintCapabilities, all of the functions available with a device, and setting items thereof are listed. The application selects the setting of each function based on this PrintCapabilities, and creates a print ticket as printing settings. Also, with the PrintCapabilities, in addition to a function list and choices thereof, there is a specification wherein a DisplayName property 1303 is described. The DisplayName property stores the text string for display corresponding to each of functions and setting items. The application can refer to the DisplayName property within the PrintCapabilities obtained from the printer driver, to display text string for display stored in the DisplayName property as a UI text string of a printing setting screen.

With the PrintCapabilities, capability other than system-stipulated printing functions, and a text string for UI display can be obtained, whereby a more advanced printing setting screen can be configured, as compared with DeviceCapabilities API.

FIG. 33 is a block diagram for describing the configuration of a printing control module according to the information processing device. The present example is a diagram illustrating how a DEVMODE and print ticket are exchanged at each layer of an application layer, OS layer, and driver layer with printing setting processing.

First, a Win32 application 504 located on the upper left exchanges a DEVMODE with a printer driver 501 through a Win32 API 503. Also, the Win32 application 504 obtains device capability information at the DeviceCapabilities through the Win32 API 503.

On the other hand, a flow located on the upper right is a processing example wherein a print ticket compatible application 506 exchanges a print ticket and PrintCapabilities with the printer driver 501. The print ticket compatible application 506 obtains capability information at the PrintCapabilities through a print ticket API 505, and specifies printing settings using a print ticket.

In the case of actually printing on a printer device from the print ticket compatible application 506, a user determines final printing settings by operating the printing setting screen of each of the print ticket compatible application 506 and printer driver. At this time, a printing setting UI of the print ticket compatible application 506 causes the user to select the same function as the content of the UI of the printer driver in some cases.

There is a technique such as described in Japanese Patent Laid-Open No. 11-143664 as a technique for informing the user of such a redundant function between the application and printer driver. With Japanese Patent Laid-Open No. 11-143664, a redundant function is informed to the user by displaying the printer driver and application UI simultaneously using support software. Upon the UI of the printer driver being displayed on a display device connected to the information processing device from an application installed in the information processing device, function names are displayed with different text strings in some cases even if the function names indicate the same function. This may cause the user to make an error in operation.

An example of this is a case wherein when printing multiple copies, terms indicating a function for outputting for each copy differ such as “print by copies” and “sort”. This is an example, and there is a case other than this wherein terms indicating a function for printing by laying out multiple logical pages to one physical sheet differ such as “layout printing” and “number of pages per one sheet”.

There is another problem wherein, when the display language of the application and the display language of the printer driver differ, the user is confused regarding the correlation between the two. With the above-mentioned technique of Japanese Patent Laid-Open No. 11-143664, redundant functions can be understood by displaying the printer driver and application UI simultaneously, but it is necessary for the user to prepare particular support software, which is troublesome for the user.

As described above, with an operating system, e.g., Windows (registered trademark) Vista, there is an arrangement wherein, when informing the application of printer capability information using the PrintCapabilities, the UI display text string of each function is provided. When employing this function, the terms of the printer driver and the terms of the application are integrated. However, when applying this arrangement to the application UI, it can be conceived that a UI text string to be displayed differs for each driver of a printer to be printed. Particularly, this can be applied to a case wherein output devices belong to multiple printer venders.

Thus, upon switching output devices by the application, the same function is displayed with different terms, so there is no consistency within the one application, which provides confusion to the user. Thus, with the relation between the application and printer driver, there is a case wherein text strings displayed on the UI differ depending on when setting a printing function from the application through a user interface, and when setting a printing function from the printer driver. Therefore, there is a problem wherein the user is prevented from clearly recognizing printing setting items.

### SUMMARY OF THE INVENTION

The present invention has been directed to an arrangement wherein characters displayed as a function of a printer driver can be displayed so as to be identical to the characters displayed as a function of an application.

An information processing device to which an embodiment of the present invention has been applied includes the following configuration.

An information processing device according to an embodiment of the present invention includes: a first obtaining unit configured to obtain printer capability information from a printer driver; a second obtaining unit configured to obtain text string information corresponding to a function based on the printer capability information obtained from the first obtaining unit; and an instructing unit configured to perform instructions for displaying characters of the function displayed on a printer driver screen using characters of the text string information obtained by the second obtaining unit.

Also, an information processing device according to an embodiment of the present invention includes: an output unit configured to output printer capability information to an application; a reception unit configured to receive instructions from an application for displaying characters of a function displayed on a printer driver screen using text string information corresponding to the function obtained based on the printer capability information output to the application by the output unit; and a display unit configured to display the characters of the function displayed on the printer driver screen based on the instructions received by the reception unit.

Further features of the present invention will become apparent from the following description of exemplary embodiments with reference to the attached drawings.

### BRIEF DESCRIPTION OF THE DRAWINGS

FIG. 1 is a block diagram illustrating an example of a printer control system including an information processing device according to some embodiments of the present invention, and printing device.

FIG. 2 is a block diagram for describing the module configuration of the host computer shown in FIG. 1.

FIG. 3 is a schematic view for describing a relation between an application installed in the host computer shown in FIG. 1, and a printer driver for each printer.

FIG. 4 is a schematic view for describing the relation between an application installed in the host computer shown in FIG. 1, and a printer driver for each printer in detail.

FIG. 5 is a diagram illustrating an example of an interface function disclosed by a printer driver to be installed in the information processing device.

FIG. 6 is a diagram illustrating an example of an interface function disclosed by the printer driver to be installed in the information processing device.

FIG. 7A is a diagram for describing the display control of a user interface of the information processing device according to the present embodiment.

FIG. 7B is a flowchart illustrating an example of a first data processing procedure of the information processing device according to the present embodiment.

FIG. 8 is a diagram illustrating an example of text string table information managed by the information processing device according to the present embodiment.

FIG. 9 is a diagram illustrating an example of an application printing setting screen displayed on the display shown in FIG. 1.

FIG. 10 is a flowchart illustrating an example of a second data processing procedure of the information processing device according to the present embodiment.

FIG. 11 is a diagram illustrating an example of PrintTicket generated by the information processing device according to the present embodiment.

FIG. 12 is a flowchart illustrating an example of a third data processing procedure of the information processing device according to the present embodiment.

FIG. 13 is a diagram illustrating an example of text string table information held within the sub module shown in FIG. 4.

FIG. 14 is a diagram illustrating an example of the text string table information held by the sub module shown in FIG. 4.

FIG. 15 is a diagram illustrating an example of the user interface which can be displayed by the information processing device according to the present embodiment.

FIG. 16 is a diagram illustrating an example of the user interface which can be displayed by the information processing device according to the present embodiment.

FIG. 17 is a diagram illustrating an example of the text string table information held by the driver proper shown in FIG. 5.

FIG. 18 is a diagram illustrating an example of the text string table information held by the driver proper shown in FIG. 5.

FIG. 19 is a diagram illustrating an example of the user interface which can be displayed by the information processing device according to the present embodiment.

FIG. 20 is a flowchart illustrating an example of a fourth data processing procedure of the information processing device according to the present embodiment.

FIG. 21 is a diagram illustrating an example of the user interface displayed on the display 10 shown in FIG. 1.

FIG. 22 is a flowchart illustrating an example of a fifth data processing procedure of the information processing device according to the present embodiment.

FIG. 23 is a diagram illustrating an example of the text string table information held by the printer driver of the information processing device according to the present embodiment.

FIG. 24 is a diagram illustrating an example of the text string table information held by the printer driver of the information processing device according to the present embodiment.

FIG. 25 is a flowchart illustrating an example of a sixth data processing procedure of the information processing device according to the present embodiment.

FIG. 26 is a diagram illustrating an example of the user interface displayed on the display shown in FIG. 1.

FIG. 27 is a diagram for describing a memory map of a computer-readable storage medium storing various types of data processing program which can be read by the information processing device according to an embodiment of the present invention.

FIG. 28 is a diagram for describing the structure of an electronic document format which can be processed by the information processing device.

FIG. 29 is a diagram illustrating an example printing settings which can be correlated with each part of the electronic document shown in FIG. 28.

FIG. 30 is a diagram for describing a memory block according to a printing system of the related art.

FIG. 31 is a diagram illustrating an example of the DEVMODE public portion shown in FIG. 30.

FIG. 32 is a diagram illustrating an example of PrintCapabilities which the printer driver to be installed in the information processing device returns to an application.

FIG. 33 is a block diagram for describing the configuration of a printing control module according to the information processing device.

### DESCRIPTION OF THE EMBODIMENTS

Next, embodiments for implementing the present invention will be described with reference to the drawings.

### Description of System Configuration

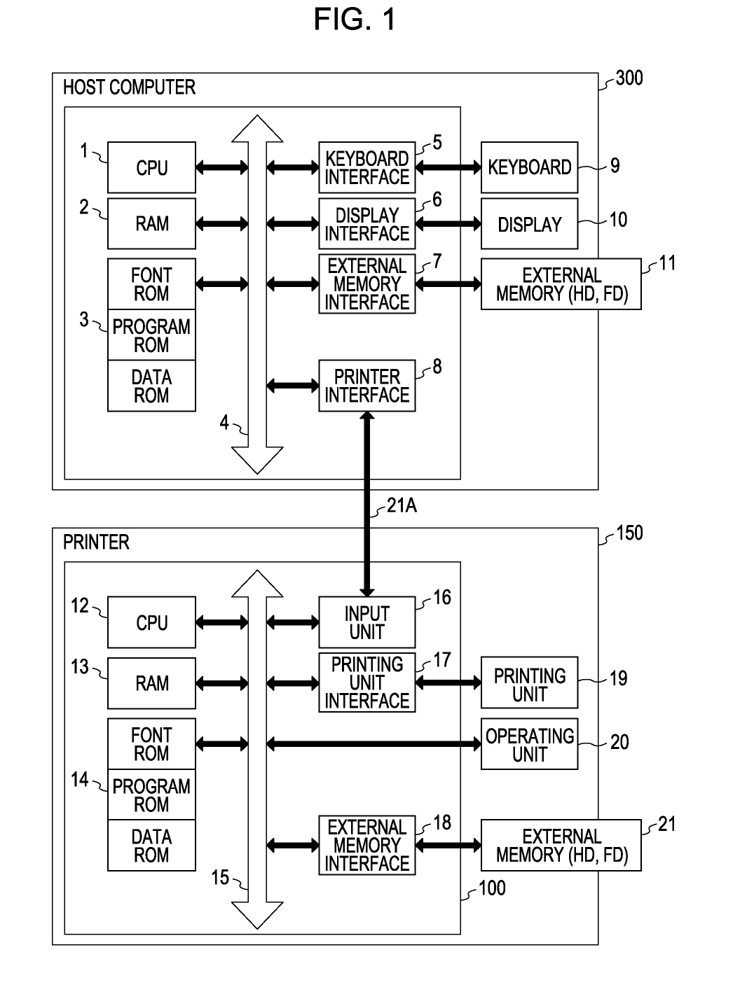

FIG. 1 is a block diagram illustrating an example of a printer control system including an information processing device according to some embodiments of the present invention, and a printing device. Note that the present invention can be applied to a single device, a system made up of multiple devices, or even a system wherein connection is made through a network such as a LAN, WAN, or the like to perform processing, as long as functions of the present invention can be executed, unless otherwise noted.

In FIG. 1, reference numeral 300 denotes a host computer, which is connected to a printer 150 through a two-way interface 21A so as to communicate therewith. With the host computer 300, reference numeral 1 denotes a CPU, which executes document processing wherein figures, images, characters, tables (including table calculation and so forth), and so forth are mixed, based on a document processing program or the like stored in program ROM of ROM 3, or external memory 11. Note that the CPU 1 controls each device connected to a system bus 4 as a whole. Also, a flexible disk, hard disk, and so forth are included in the external memory 11.

Also, an operating system (hereafter, referred to as “OS”) which is a control program of the CPU 1, and so forth are stored in the program ROM of the ROM 3, or external memory 11. Further, font data employed at the time of the above-mentioned document processing, and so forth are stored in font ROM of the ROM 3, or external memory 11. Also, various types of data employed at the time of performing the above-mentioned document processing are stored in data ROM of the ROM 3, or external memory 11.

Reference numeral 2 denotes RAM, which serves as main memory, work area, and so forth of the CPU 1. Also, the RAM 2 is configured so as to increase memory capacity by mounting optional RAM.

Reference numeral 5 denotes a keyboard interface, which controls key input from a keyboard 9 or unshown pointing device. Reference numeral 6 is a display interface, which controls display of a display 10.

Reference numeral 7 is an external memory interface, which controls access to the external memory 11 such as a hard disk (HD) storing a boot program, various types of application, font data, user files, editing files, printer driver, and so forth, a flexible disk (FD), and so forth.

Reference numeral 8 denotes a printer interface, which is connected to the printer 150 through the predetermined two-way interface 21A, and executes communication control processing with the printer 150.

Note that the CPU 1 executes, for example, rasterizing processing of an outline font to display information RAM set on the RAM 2 to enable WYSIWYG display on the display 10. Also, the CPU 1 opens various types of window registered based on a command specified with an unshown mouse cursor or the like on the CRT 10, and executes various types of data processing.

When executing printing, the user opens a window relating to printing settings, and performs settings of the printer, and settings of a printing processing method as to a printer driver including selection of printing modes.

With the printer 150, reference numeral 100 denotes a printer controller, reference numeral 12 denotes a printer CPU (CPU), which controls devices connected to a system bus 15 as a whole. Also, the CPU 12 outputs an image signal serving as output information to a printing unit 17 connected to the system bus 15 based on a control program or the like stored in program ROM of ROM 14, or a control program or the like stored in external memory 21. Also, a control program of the CPU 12, and so forth are stored in the program ROM of the ROM 14. Font data employed at the time of generating output information, and so forth are stored in font ROM of the ROM 14, and information employed on the host computer 300, and so forth are stored in data ROM of the ROM 14 in a case wherein there is no external memory 21 such as a hard disk or the like. The CPU 12 can perform communication processing with the host computer 300 through an input unit 16, and is configured so as to inform the host computer 300 of information within the printer 150, and so forth.

Reference numeral 13 denotes RAM, which serves as main memory, work area, and so forth of the CPU 12, and is configured so as to expand memory capacity by optional ROM which will be connected to an unshown expansion port. Note that the RAM 13 is employed for an output information rasterizing area, environment data storage area, NVRAM, or the like. Access to the above-mentioned external memory 21 such as a hard disk (HD), IC card, or the like is controlled by an external memory interface 18.

The external memory 21 is connected as an option, and stores font data, an emulation program, form data, and so forth. Reference numeral 17 denotes a printing unit interface, which outputs image data to a printing unit 19, and also informs the CPU 12 of information detected from various types of sensor of the printing unit 19.

Also, reference numeral 20 denotes an operating unit, wherein switches for operations, an LED display, and so forth are provided. Also, the above-mentioned external memory 21 is not restricted to one piece of memory, and an arrangement may be made wherein at least one or more pieces of the external memory 21 are provided, and are configured so as to connect an optional font card in addition to embedded fonts, and multiple pieces of external memory storing a program for interpreting a printer control language of a different language system.

Further, the external memory 21 may include unshown NVRAM so as to store printer mode setting information from an operating panel 20. Note that the operating panel 20 includes a touch-panel-type liquid crystal display, and is configured so as to display a function setting screen as to the user.

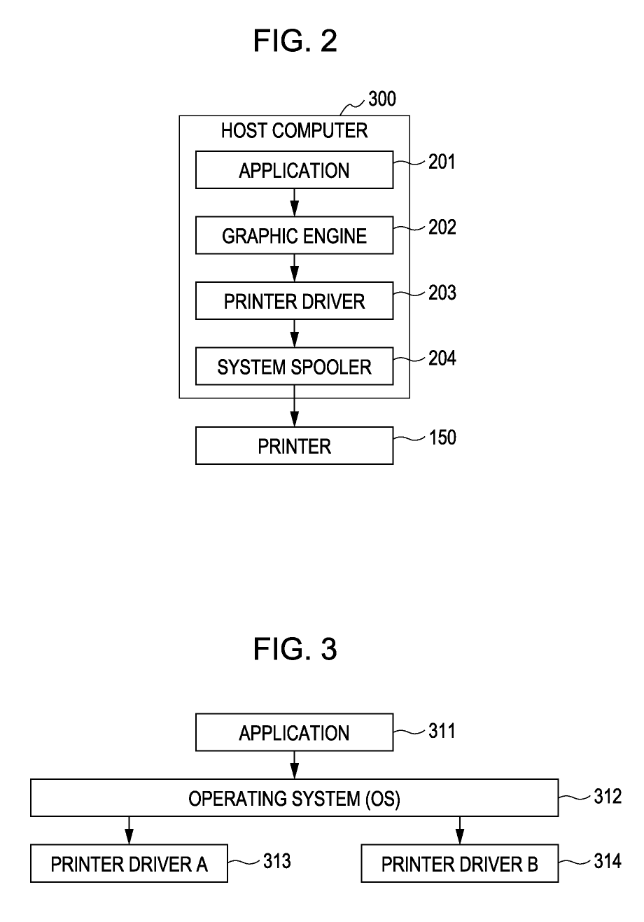

FIG. 2 is a block diagram for describing the module configuration of the host computer 300 shown in FIG. 1. The present example corresponds to modules for performing typical printing data generation processing at the host computer 300. In FIG. 2, an application 201, graphic engine 202, printer driver 203, and system spooler 204 exist as files saved in the external memory 11. These files are program modules each of which is loaded to the RAM 2 by the OS or a module employing the module thereof, and executed by the CPU 1.

Also, the application 201 and printer driver 203 are configured so as to be added to the external memory 11 through an FD or unshown CD-ROM of the external memory 11 or an unshown network. Note that the external memory 11 is, for example, configured of a hard disk (HD) or the like. The application 201 saved in the external memory 11 is loaded to the RAM 2 and executed by the CPU 1.

On the other hand, when performing printing as to the printer 150 from the application 201, the graphic engine 202 similarly loaded to the RAM 2 and become executable is employed to perform output (drawing). The graphic engine 202 loads the printer driver 203 prepared for each printer to the RAM 2 from the external memory 11, and the printer driver 203 converts the output of the application 201 into a printer control command. Thus, the printer control command converted by the printer driver 203 is arranged to be output to the printer 150 through the system spooler 204 loaded to the RAM 2 by the OS, and the two-way interface 21A.

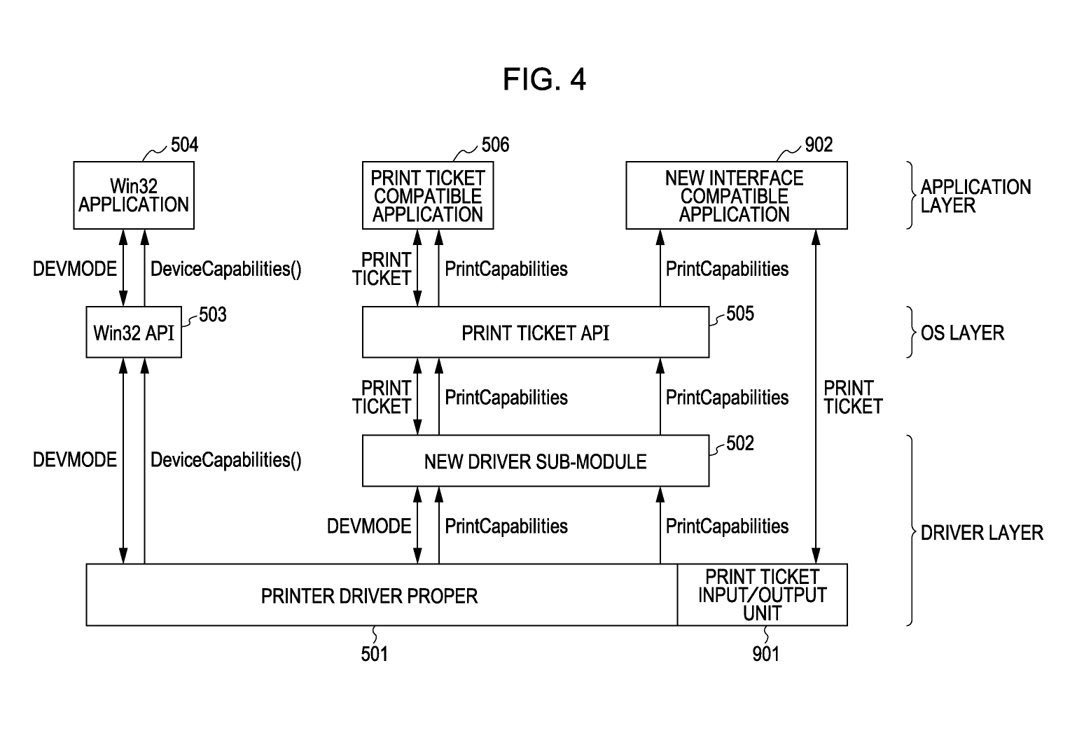

FIG. 3 is a schematic view for describing the relation between an application to be installed to the host computer 300 shown in FIG. 1 and the printer driver for each printer. In FIG. 3, an application 311 calls up various types of functions (API) provided by an operating system (OS) 312 to perform processing. The OS 312 calls up a function (DDI) provided by a printer driver 313 or 314 of the printer of which the processing relating to printing has been selected to perform processing thereof, thereby enabling printing to the printer selected from the application 311. Note that in the drawing, the difference between the printer drivers 313 and 314 is represented as printer drivers A and B. At this time, printing setting data of the printer is exchanged between the printer drivers 313 and 314, OS 312, and application 311, such as shown in FIG. 4.

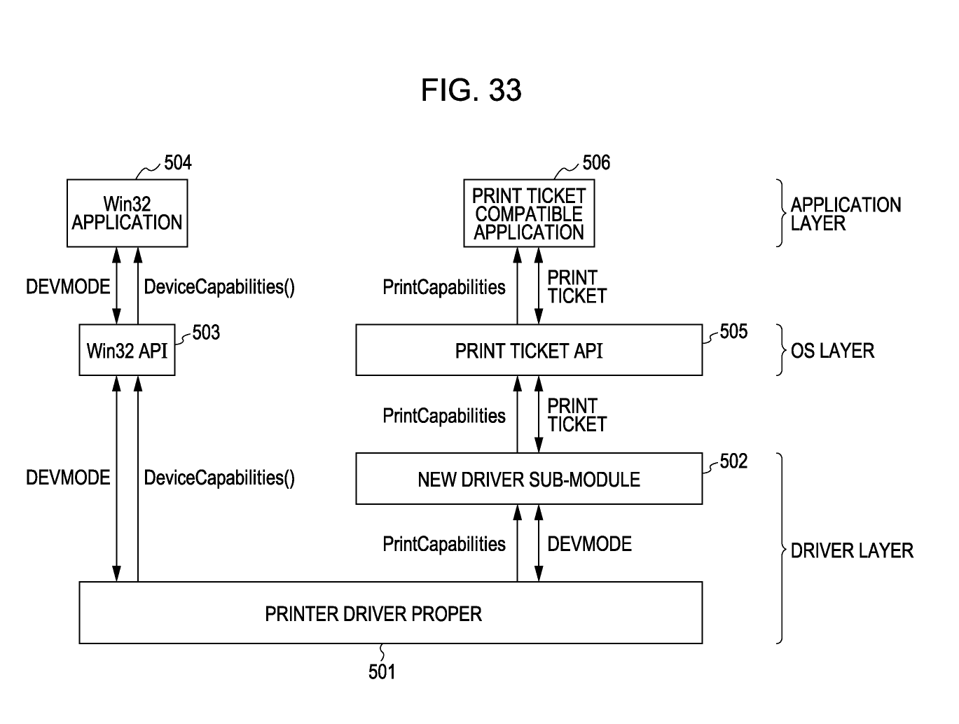

FIG. 4 is a schematic view for describing the relation between an application installed in the host computer 300 shown in FIG. 1, and a printer driver for each printer in detail. In FIG. 4, the case of performing printing settings from the Win32 application 504 or printer ticket compatible application 506 have been described in FIG. 33, so description thereof will be omitted here.

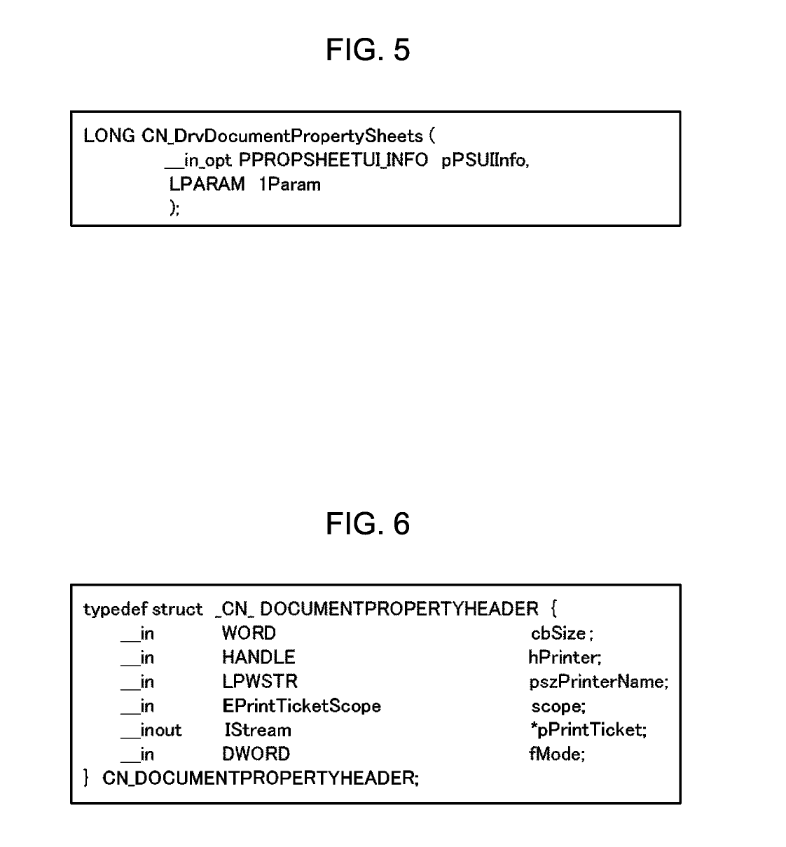

A print ticket input/output 901 for directly managing input/output of a print ticket is provided in the printer driver 501. Subsequently, a unique interface which is not involved by the OS is provided, such as shown in FIG. 5. This new interface compatible application 902 (hereafter, referred to as “application 902”) calls up not the print ticket API 505 but instead the unique interface which discloses the printer driver shown in FIG. 5. Thus, a print ticket can be passed to the print ticket input/output unit 901 directly from the application 902.

FIGS. 5 and 6 are diagrams illustrating an example of an interface function that a printer driver to be installed in the information processing device according to the present embodiment discloses. Also, the present example is a part of the unique interface that the printer driver discloses.

FIG. 5 is an example wherein the unique interface function that the printer driver discloses is defined as a function of C language. This function has generally the same function specification as a printer driver interface function DrvDocumentPropertySheets defined by the OS except that the names thereof differ, so description thereof will be omitted here. Note that the details of the DrvDocumentPropertySheets function can be confirmed, for example, with http://msdn2.microsoft.com/en-us/library/ms801131.aspx.

FIG. 6 is a diagram for describing a part of a structure employed by the function shown in FIG. 5. The present example is an example with specification simulating a DOCUMENTPROPERTYHEADER structure defined by the OS. Note that the details of the DOCUMENTPROPERTYHEADER structure can be confirmed, for example, with http://msdn2.microsoft.com/en-us/library/aa506306.aspx.

Description will be made below regarding only the difference between the DOCUMENTPROPERTYHEADER structure and CN_DOCUMENTPROPERTYHEADER structure. With the DOCUMENTPROPERTYHEADER structure, a DEVMODE structure that inputs and outputs is held as a member, and further the size of a DEVMODE for output is held as a member, but these do not exist within the CN_DOCUMENTPROPERTYHEADER structure at all. Instead, an input/output print ticket held as a member (IStream *pPrintTicket (argument)).

Description will be made below regarding a display flow of the printing setting screen of the application, and a display flow of the printing setting screen of the printer driver using the interface functions shown in FIGS. 5 and 6.

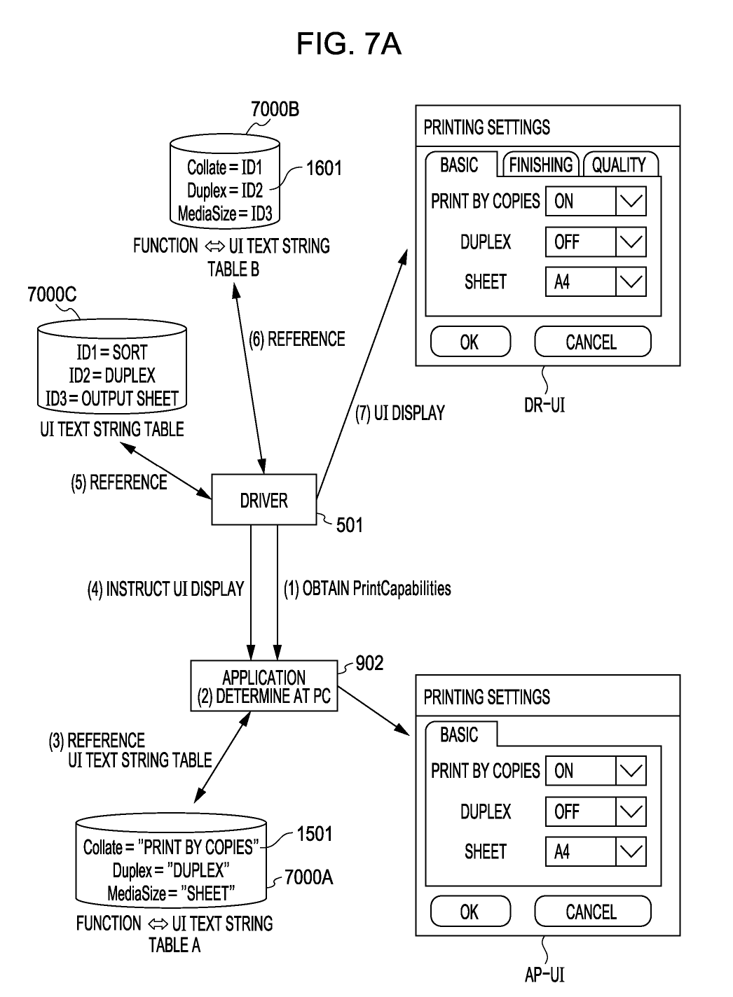

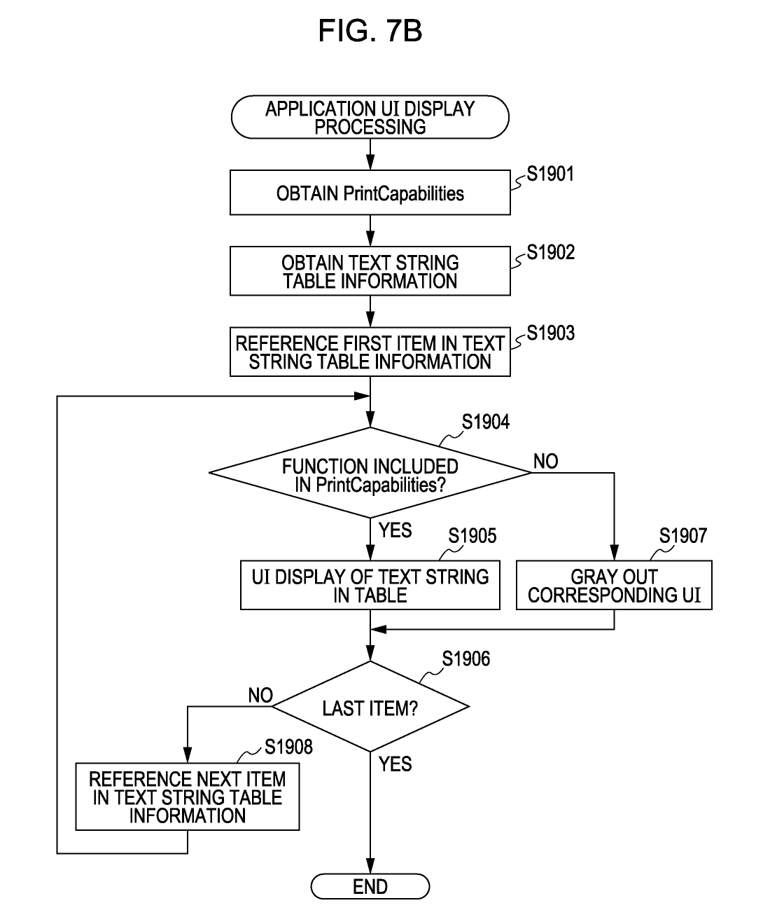

FIG. 7A is a diagram for describing display control of the user interface of the information processing device according to the present embodiment. The present example corresponds to display control wherein a printing setting function text string displayed on the user interface provided by the printer driver is replaced so as to be identical to the text string indicating the printing setting function displayed by the user interface of the application. Note that the same components as those in FIG. 4 are denoted with the same reference numerals.

In FIG. 7A, reference numeral 7000A denotes a UI character table, which holds a function name and text string table information 1501 of the UI corresponding thereto.

Reference symbol AP-UI denotes a printing setting screen by the application, and the application 902 refers to the text string table information 1501 to display this on the display 10.

Reference numeral 7000B denotes a UI character table, which holds a function name on the driver side and text string table information 1601 of the UI corresponding to thereto.

Reference numeral 7000C denotes a text string table, which holds the text string data corresponding to the text string ID of the UI character table 7000B by ID.

Reference symbol DR-UI denotes a printing setting screen by the driver, which usually differs from the text string of a function displayed on the printing setting screen AP-UI, but corresponds to a state wherein the printing setting screen DR-UI and printing setting screen AP-UI have the same display because later-described replacement processing has been executed.

The processing on the application 902 side will be described below. Note that each of (1) through (7) shows processing in FIG. 7A.

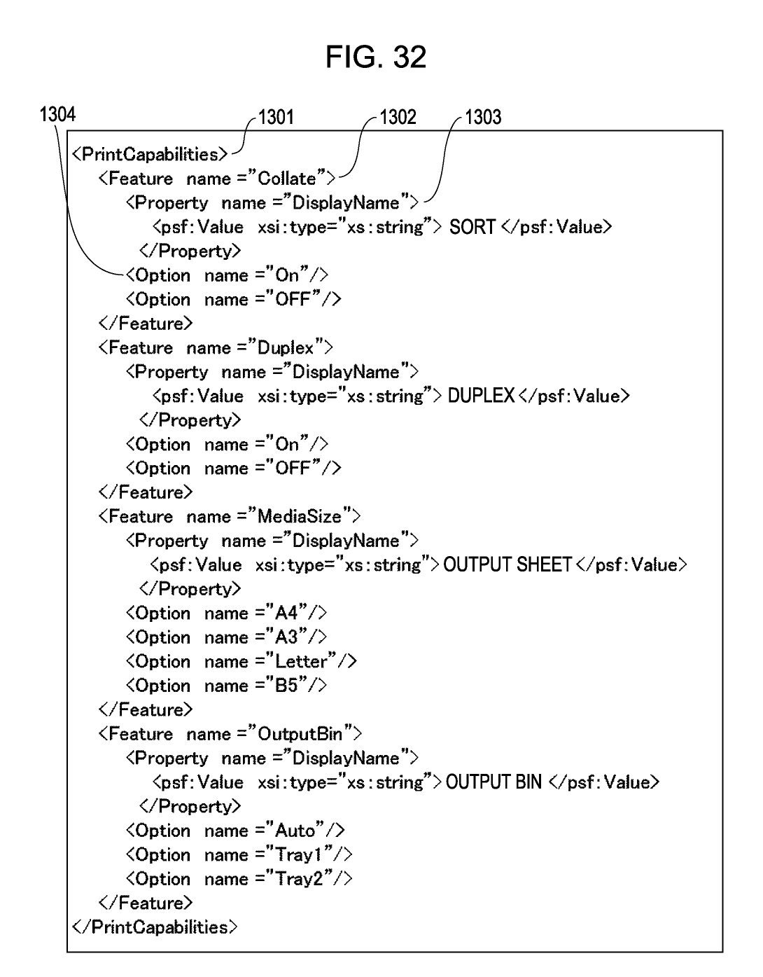

First, with the processing (1), the capability information (hereafter, referred to as PrintCapabilities) of the printer having a data structure shown in FIG. 32 is obtained from the printer driver 501.

Next, with the processing (2), the application 902 determines the function displayed by the UI of the application 902 within the PrintCapabilities obtained from the printer driver 501.

Next, with the processing (3), the application 902 references the text string table information 1501 held within the UI character table 7000A to obtain the text string information corresponding to the function determined by the processing (2).

Thus, as shown in FIG. 7A, for example, if the function within the PrintCapabilities obtained from the printer driver 501 is “Collate”, the application 902 obtains a text string of “print by copies” from the text string table information 1501.

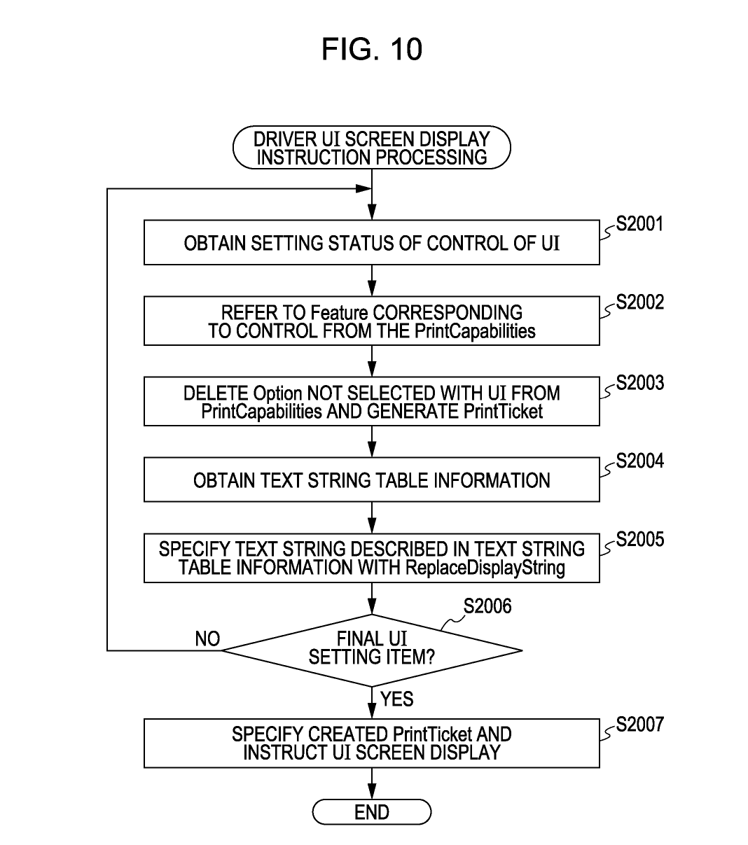

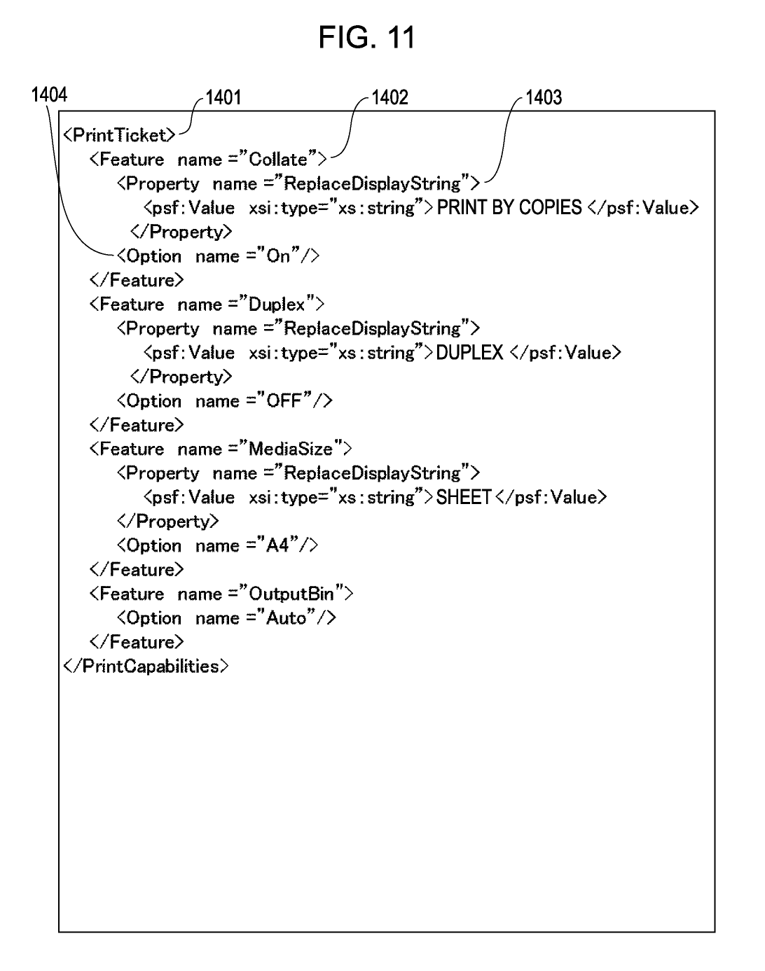

Next, with the processing (4), the text string obtained by the processing (3) is specified in the description portion of a function to be subjected to text string replacement within the PrintTicket shown in FIG. 11 as ReplaceDisplayString, specified at the time of open of the driver UI, based on later-described processing shown in FIG. 10.

A description example of the PrintTicket to be specified is shown below.

<feature name = “Collate”>
<property name = “ReplaceDisplayString”>
<value> print by copies </value>
</property>
<option name = “ON”/>
</feature>

Next, the processing at the printer driver 501 side will be described. First, with the processing (5), a text string for displaying the function of the printing setting screen DR-UI is obtained by referencing the text string table 7000C within the printer driver 501. In this state, the text string corresponding to the function set by the printer driver 501 is displayed on the UI screen, so the text string relating to the function differs between the printing setting screen DR-UI and printing setting screen AP-UI in some cases.

Next, with the processing (6), the printer driver 501 references the function name on the driver side held in the UI character table 7000B, and the text string information 1601 of the UI corresponding thereto.

Next, the printer driver 501 replaces the UI text string of the function wherein the ReplaceDisplayString specified by the PrintTicket generated from the application 902 is specified, with the specified text string.

Subsequently, with the processing (7), the text string replaced in the processing (6) is displayed as the printing setting screen DR-UI at the time of open of the driver UI, thereby matching the display of the printing setting screen DR-UI and the display of the printing setting screen AP-UI.

Note that a text string corresponding to the function not included in the PrintCapabilities obtained from the printer driver 501 is displayed grayed out, such as described later.

Thus, with the present embodiment, when the application 902 displays the UI provided to the printer driver 501, the application 902 specifies the function name displayed on the own UI within the PrintTicket instructing the printer driver 501.

Subsequently, the printer driver 501 makes up the driver UI by replacing the function name displayed on the own UI with the function name of the application specified with the PrintTicket obtained from the application 902.

Thus, even in a case wherein the display language corresponding to the UI display of the application, and the display language corresponding to the UI display of the printer driver differ, the function text string on the driver side can be unified with the function text string corresponding to the application 902.

Accordingly, the user has no uncomfortable feeling between the text string indicating the function of the UI screen which the printer driver provides, and the text string indicating the function of the UI screen which the application 902 provides, thereby improving operability.

FIG. 7B is a flowchart illustrating an example of a first data processing procedure of the information processing device according to the present embodiment. The present example is a processing example wherein the printing setting screen managed by the application 902 itself shown in FIG. 4 is displayed. Note that reference symbols S1901 through S1908 are respective steps. Also, the respective steps are realized by the CPU 1 loading the application 902 to the RAM 2 to execute this.

The program of the application 902 is stored in the external memory 11 of the host computer 300, and is read into to the RAM 2 and executed by the CPU 1.

First, in step S1901, the application 902 obtains the capability information of the printer device. The application 902 obtains the PrintCapabilities of the printer device through the print ticket API 505. Here, the PrintCapabilities in an XML format such as shown in FIG. 32 is returned to the application 902. Note that processing wherein the application 902 obtains the PrintCapabilities of the printer device 501 corresponds to first obtaining processing, and processing wherein the application 902 obtains the text string corresponding to the function in later-described S2004 corresponds to second obtaining processing.

The four Features of Collate, Duplex, MediaSize, and OutputBin are included in the PrintCapabilities shown in the example in FIG. 32. Also, a DisplayName property is specified in each of the Features.

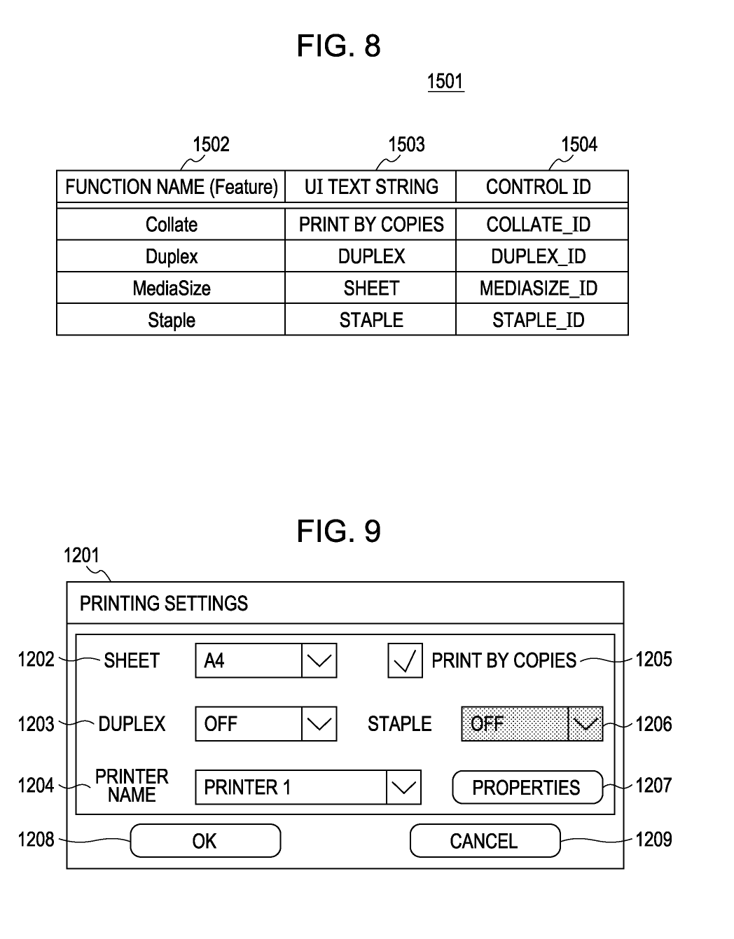

Subsequently, in step S1902, the application 902 obtains a function name, and the text string table information 1501 of the UI on the application side corresponding thereto, such as shown in FIG. 8.

As shown in FIG. 8, a UI text string 1503 corresponding to a function name (Feature name) 1502, and a control ID 1504 of the UI are stored in the text string table information 1501.

Next, in step S1903, the application 902 references the text string table information 1501 obtained in step S1902 to obtain the first function information.

Next, in step S1904, the application 902 determines whether or not the function obtained from the text string information 1501 in step S1903 is a function included in the PrintCapabilities obtained from the printer driver 501 in step S1901. Here, in a case wherein the application 902 determines that the obtained function is included in the PrintCapabilities, the application 902 proceeds to step S1905.

Subsequently, in step S1905, the application 902 displays the application UI on the display 10 of the host computer 300 using the text string according to the Feature name (function name) 1502 stored in the text string information 1501. Here, the application UI corresponds to the printing setting screen AP-UI shown in FIG. 7A.

Next, in step S1906, the application 902 determines whether or not the function information currently obtained is the final item of the text string table information 1501, and in a case wherein the application 902 determines that the function information currently obtained is the final item, the application 902 ends the present processing.

On the other hand, in a case wherein the application 902 determines that the function information currently obtained is not the final item, the application 902 proceeds to step S1908, obtains the next item within the text string table information 1501, following which repeats the processing in steps S1904 through S1906.

On the other hand, in step S1904, in a case wherein the application 902 determines that the obtained function does not exist within the PrintCapabilities obtained from the printer driver 501, the application 902 proceeds to step S1907. Subsequently, in step S1907, the application 902 displays the UI control corresponding to the function grayed out, and informs the user as an unavailable function, and proceeds to step S1906.

FIG. 9 is a diagram illustrating an example of a printing setting screen 1201 of the application displayed on the display 10 shown in FIG. 1. The present screen is a display screen example by the application 902. The screen shown in FIG. 9 is an example wherein a sheet setting control 1202, duplex setting control 1203, and print by copies setting control 1205 are each displayed with the UI text string within the text string table information 1501.

Also, a staple setting control 1206 corresponding to a function not included in the PrintCapabilities is displayed grayed out (indicated with shading in FIG. 9).

The printing setting screen 1201 of the application further includes a printer selection control 1204 for selecting a printer, and a property button 1207 for displaying the printing setting screen of the printer driver 501. Further, the printing setting screen 1201 of the application is configured so as to include an OK button 1208 for determining the printing setting screen, and a cancel button 1209.

Next, description will be made regarding processing wherein the property button 1207 of the printing setting screen 1201 of the application is pressed, and the printing setting screen of the printer driver 501 is displayed from the application 902.

FIG. 10 is a flowchart illustrating an example of a second data processing procedure of the information processing device according to the present embodiment. The present example is an instruction example wherein, with the screen shown in FIG. 9 which the application 902 displayed, the printing setting screen of the printer driver is displayed from the application which is executed at the time of the property button 1207 being pressed by the user's operation.

Note that reference symbols S2001 through S2007 denote respective steps. Also, the respective steps are realized by the CPU 1 loading the application 902 to the RAM 2 to execute this.

In step S2001, the application 902 obtains the selection state of control relating to the printing settings within the printing setting screen 1201. Next, in step S2002, the application 902 references the Feature corresponding to the control of which the state was obtained in step S2001, of the Feature list within the PrintCapabilities obtained from the printer driver 501 in step S1901.

Next, in step S2003, the application 902 eliminates Options other than the items corresponding to the setting items in a selected state, of the Option list of the referenced Feature. As a result thereof, as shown in FIG. 11, the application 902 generates a PrintTicket 1401 in a state wherein only the Option of a particular setting item is described in the Feature.

FIG. 11 is a diagram illustrating an example of the PrintTicket generated at the information processing device according to the present embodiment. The present example is an example wherein the PrintTicket in a state wherein only an Option 1404 of a particular setting item is generated in a Feature 1402 by the application 902.

The example in FIG. 11 illustrates a state wherein “On” Option is selected for a “Collate” Feature, and “OFF” Option is selected for a “Duplex” Feature, respectively.

Next, in step S2004, the application 902 obtains the text string table information 1501. Subsequently, in step S2005, the application 902 references the text string table information 1501 to obtain the text string information of a function relating to the current control, and specifies this in the PrintTicket 1401 shown in FIG. 11 as a ReplaceDisplayString property.

With the example in FIG. 11, “print by copies” which is a text string corresponding to the Collate within the text string table information 1501 of the application is described as a ReplaceDisplayString property 1403 of the “Collate” Feature.

Next, in step S2006, the application 902 determines whether or not the printing setting control referenced in step S2001 is for the final setting item. Here, in the case of the application 902 determining that the control is for the final setting item, the application 902 proceeds to the next step S2007. Subsequently, in step S2007, the application 902 follows the instructions for displaying the printing setting screen of the printer driver to specify the generated PrintTicket shown in FIG. 6 and instruct display of the printing setting screen of the printer driver 501, and ends the present processing.

On the other hand, in a case wherein the application 902 determines in step S2006 that the control is not for the final setting item, the application 902 returns to step S2001, obtains the control state of the next printing setting, and repeats this processing until the printing setting control for all of the setting items is completed.

Eventually, the state of the printing setting screen of the application is reflected on an argument pPrintTicket of the API shown in FIG. 6. Further, the PrintTicket such as shown in FIG. 11 is specified wherein a UI text string is described in the ReplaceDisplayString property.

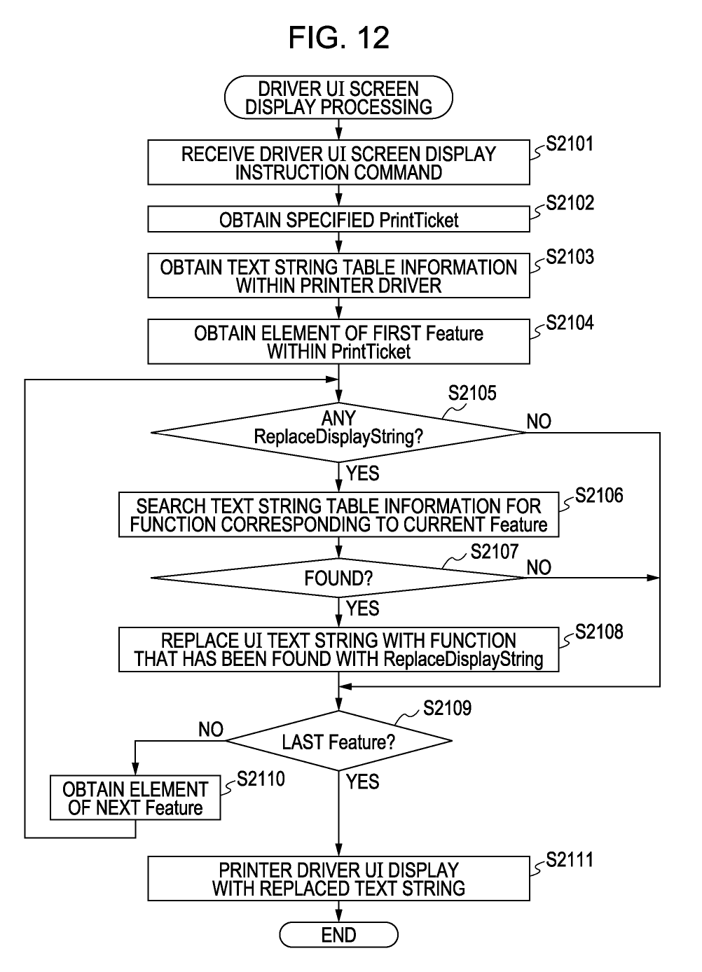

FIG. 12 is a flowchart illustrating an example of a third data processing procedure of the information processing device according to the present embodiment.

The present example is a processing example wherein, with the screen shown in FIG. 9 which the application 902 displayed, the printing setting screen on the printer driver side after the property button 1207 being pressed by the user's operation is displayed.

More specifically, the present processing corresponds to a part of a processing flow in a case wherein, with calling up of the Cn_DrvDocumentPropertySheets function shown in FIG. 5, display of the user interface is instructed as to the printer driver 501. Note that the instructions for display of the user interface are equivalent to a case wherein an fMode member of the CN_DOCUMENTPROPERTYHEADER structure shown in FIG. 6 is set to a DM_IN_PROMPT.

Also, reference symbols S2101 through S2111 are respective steps. Also, the respective steps are realized by the CPU 1 loading a sub module 502 to the RAM 2 to execute this. Note that the program of the printer driver 501 is stored in the external memory 11 of the computer, and is read into the RAM 2 and executed by the CPU 1.

In step S2101, the sub module 502 receives a command on the printer driver side, which corresponds to the display instructions of the printing setting screen in step S2007 by the application 902 shown in FIG. 10.

Next, in step S2102, the sub module 502 obtains the PrintTicket specified in the pPrintTicket of the API shown in FIG. 6.

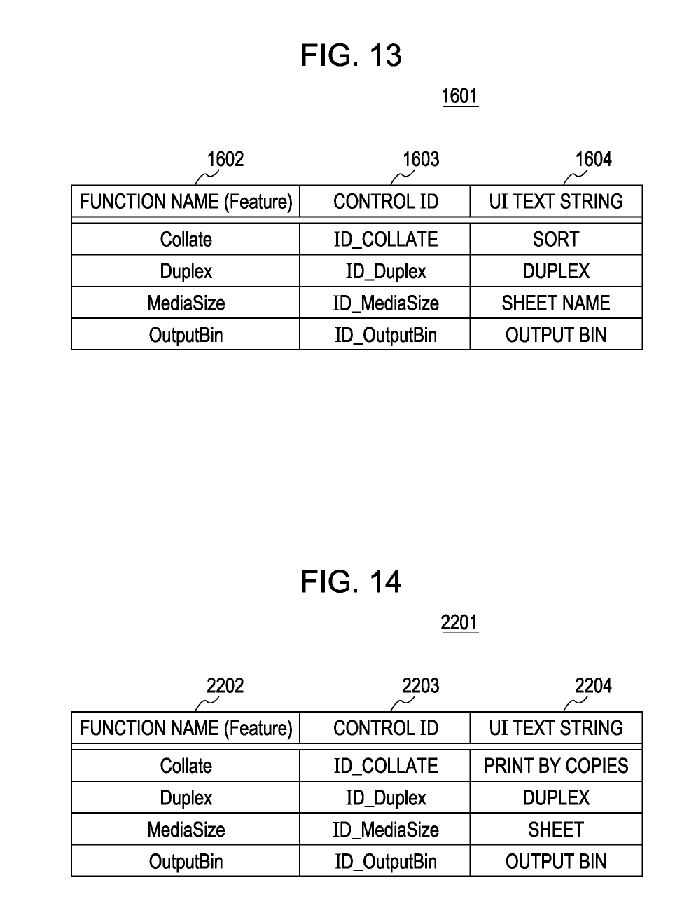

Next, in step S2103, the sub module 502 obtains the text string information 1601 held within the sub module 502 such as shown in FIG. 13, and rasterizes this in the memory.

FIG. 13 is a diagram illustrating an example of the text string information 1601 held within the sub module 502 shown in FIG. 4. In FIG. 13, a function name 1602, UI control ID 1603, and UI text string 1604 corresponding to the function thereof are stored in the text string table information 1601 in a correlated manner.

In step S2104, the sub module 502 references the first Feature within the PrintTicket obtained from the application 902 in step S2102, and in step S2105 determines whether or not the ReplaceDisplayString property exists within the referenced Feature.

Here, in a case wherein the sub module 502 determines in step S2105 that the ReplaceDisplayString exists, in step S2106 the sub module 502 searches the function name identical to the Feature currently referenced within the text string table information 1601 obtained in step S2103.

Next, in step S2107, the sub module 502 determines whether or not the identical function name exists in step S2106. Here, in a case wherein the sub module 502 determines that the identical function name exists in step S2106, the sub module 502 proceeds to step S2108. Subsequently, in step S2108, the sub module 502 replaces the UI text string 1603 of the identical function name with the ReplaceDisplayString text string within the specified PrintTicket. Thus, the UI text string “sort” shown in FIG. 13 is replaced with the text string “print by copies” specified with the PrintTicket generated by the application 902.

On the other hand, in a case wherein the sub module 502 determines in step S2107 that no identical function name is searched, the sub module 502 proceeds to step S2109 without performing any more. Subsequently, in step S2109, the sub module 502 determines whether or not the currently referenced Feature is the final Feature within the PrintTicket. In a case wherein the sub module 502 determines that the currently referenced Feature is not the final Feature, in step S2110 the sub module 502 references the next Feature and proceeds to step S2105 discussed above. On the other hand, in a case wherein the sub module 502 determines that the currently referenced Feature is the final Feature, in step S2111 the sub module 502 displays the UI screen of the printer driver on the display 10 in accordance with the UI text string 2204 of the text table information 2201 such as shown in FIG. 14, of which the UI text string has been replaced.

FIG. 14 is a diagram illustrating an example of the text string table information 2201 held by the sub module 502 shown in FIG. 4. At this time, the text string of the control ID 2203 correlated with the function name 2202 of each function within the text string table information 2201 is replaced with the UI text string 2204 specified with the PrintTicket obtained from the application 902, and held in the sub module 502.

With the text string table information 2201 shown in FIG. 14, the UI text string (sort) of Collate is replaced with “print by copies”, the UI text string (sheet name) of MediaSize is replaced with “sheet”, which are each replaced with the text string specified by the application.

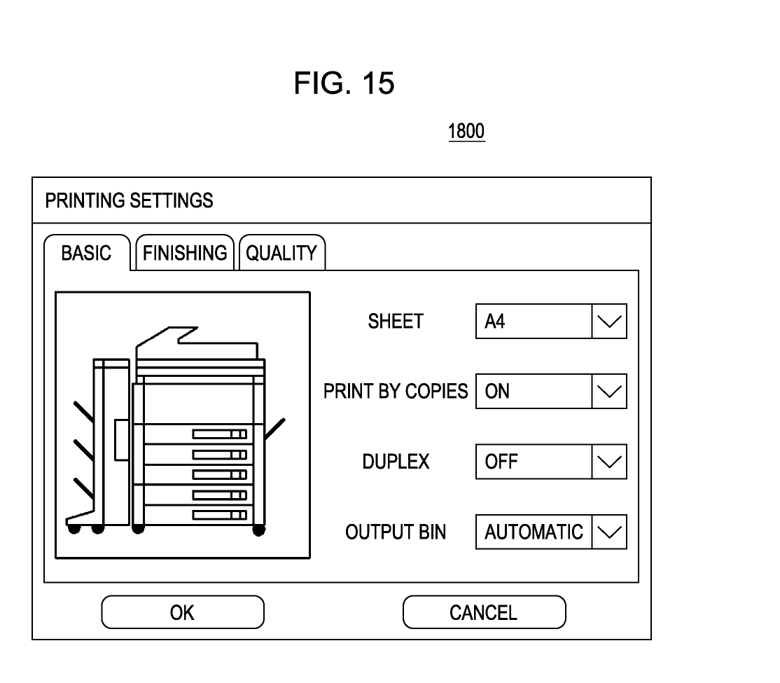

As a result thereof, a printing setting screen 1800 of the printer driver which has been replaced with the text string of the application, such as shown in FIG. 15, is displayed on the display 10.

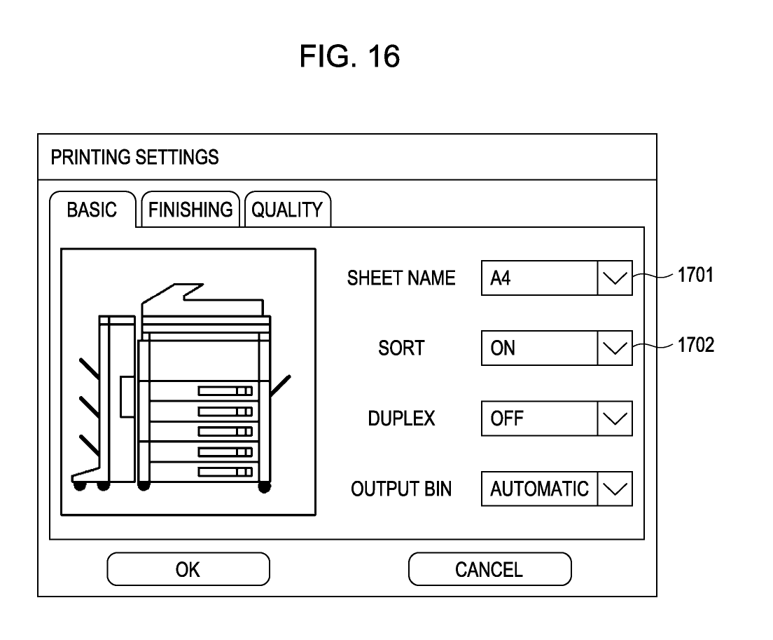

FIGS. 15 and 16 are diagrams illustrating an example of a user interface which the information processing device according to the present embodiment can display. Note that FIG. 15 corresponds to the printing setting screen wherein the replacement of a text string has been executed by the sub module 502, and FIG. 16 corresponds to a normal printing setting screen wherein the replacement of a text string has not been executed by the sub module 502.

FIG. 16 illustrates a normal printing setting screen of the printer driver, but with the setting screen shown in FIG. 15, the UI text strings of sheet name 1701 and sort 1702 are replaced with the application text strings of “sheet” and “print by copies”, respectively.

According to the above-mentioned procedure, the replacement of a UI text string of the printer driver of the printer driver with a UI text string of the application can be realized.

Description will be made below regarding a display flow of the printing setting screen of the application, processing for displaying the printing setting screen of the printer driver by employing the interface functions shown in FIGS. 5 and 6, with reference to the flowchart shown in FIG. 7B.

With the present embodiment, when replacing a UI text string of the application with a UI text string of the printer driver, the text string indicating a correctly replaced function can be displayed even in a case wherein display of the text string is in a state in which the text string exceeds the number of UI-displayable characters and a part of the text string is not displayed.

FIG. 7B is a processing flow wherein the application 902 shown in FIG. 4 displays the printing setting screen managed by itself. The program of the application 902 is stored in the external memory 11 of the computer, and is read into the RAM 2 and executed by the CPU 1.

In step S1901, the application 902 obtains PrintCapabilities from the printer driver 501 through the print ticket API 505 to obtain the capability information of the printer device. Here, the application 902 obtains the PrintCapabilities in an XML format such as shown in FIG. 13 from the printer driver 501. The example of the PrintCapabilities shown in the example of FIG. 13 is a case wherein Four Features of Collate, Duplex, MediaSize, and OutputBin are included. A DisplayName property is specified as to each of the Features.

Subsequently, in step S1902, the application 902 obtains a function name and the text string table information 1501 of the UI corresponding thereto, such as shown in FIG. 8. Here, a UI text string 1503, and a UI control ID 1504, corresponding to a function name 1502 are stored in the text string table information 1501.

In step S1903, the application 902 references the text string table information 1501 obtained in step S1902 to obtain the first function information. Next, in step S1904, the application 902 determines whether or not the function obtained in step S1903 is a function included in the PrintCapabilities obtained from the printer driver 501 in step S1901.

Here, in a case wherein the application 902 determines that the function obtained in step S1901 is included in the PrintCapabilities, the application 902 proceeds to step S1905. Subsequently, in step S1905, the application 902 employs the text string corresponding to a Feature name stored in the text string table information 1501 to display the application UI on the display 10.

Next, in step S1906, the application 902 determines whether or not the currently obtained function information is the final item of the text string table information 1501, and in the case of determining that the obtained function information is the final item, the application 902 ends the present processing.

On the other hand, in step S1905, in a case wherein the application 902 determines that the currently obtained function information is not the final item, the application 902 proceeds to step S1908. Subsequently, in step S1908, the application 902 obtains the next item within the text string table information 1501, and then repeats the processing in steps S1904 through S1906.

On the other hand, in a case wherein the application 902 determines in step S1904 that the function obtained in step S1902 is not included in the PrintCapabilities obtained from the printer driver 501 in step S1901, the application 902 displays the UI control corresponding to the function thereof grayed out, and informs the user as an unavailable function.

FIG. 9 illustrates an example of the printing setting screen 1201 of the application made up of the flow shown in FIG. 7. In FIG. 9, sheet setting control 1202, duplex setting control 1203, and print by copies setting control 1205 are displayed with the UI text strings within the test string table information 1501, respectively.

Also, a function not included in the PrintCapabilities obtained from the printer driver 501, e.g., a staple setting control 1206 corresponding to a staple function is displayed grayed out. An example wherein the staple function is displayed grayed out (indicated with shading in the drawing) is illustrated here.

The printing setting screen 1201 of the application further includes a printer selection control 1204 for selecting a printer, and a property button 1207 for displaying the printing setting screen of the printer driver. Further, the printing setting screen 1201 of the application is configured so as to include an OK button 1208 for determining the printing setting screen, and a cancel button 1209.

Next, description will be made regarding instructions wherein the property button 1207 of the printing setting screen 1201 of the application is pressed, and the application 902 controls the printer driver 501 to display the printing setting screen.

FIG. 10 shows a processing flow wherein, when the property button 1207 of the application shown in FIG. 9 is pressed, instructions for displaying the printing setting screen of the printer driver 501 are performed from the application 902. Note that the program of the application 902 according to the present flow is stored in the external memory of the computer, and is read into the RAM 2 and executed by the CPU 1.

In step S2001, the application 902 obtains the selection state of control relating to the printing settings within the printing setting screen 1201 shown in FIG. 9. Next, in step S2002, the application 902 references the Feature corresponding to the control obtained from the state of the printing setting screen 1201 in step S2001, of the Feature list within the PrintCapabilities obtained from the printer driver 501 in step S1901 shown in FIG. 7.

Subsequently, in step S2003, the application 902 eliminates Options other than the items corresponding to the setting items in a selected state, of the Option list of the referenced Feature.

As a result thereof, as shown in FIG. 11, the application 902 generates a PrintTicket 1401 in a state wherein only the Option of a particular setting item is described in the Feature. The example in FIG. 11 illustrates a state wherein “On” Option is selected for a “Collate” Feature, and “OFF” Option is selected for a “Duplex” Feature, respectively.

Next, in step S2004, the application 902 obtains the text string table information 1501. Subsequently, in step S2005, the application 902 references the text string table information 1501 to obtain the text string information of a function relating to the current control, and specifies this in the PrintTicket 1401 as a ReplaceDisplayString property.

With the example in FIG. 11, “print by copies” which is a text string corresponding to the Collate within the text string table information 1501 of the application is described as a ReplaceDisplayString property of the “Collate” Feature.

Next, in step S2006, the application 902 determines whether or not the printing setting control referenced in step S2001 is for the final setting item. Here, in the case of the application 902 determining that the control is for the final setting item, the application 902 proceeds to the next step S2007. Subsequently, in step S2007, the application 902 instructs the API 505 for instructions for displaying the printing setting screen of the printer driver 501 to display of the printing setting screen of the printer driver 501 by specifying the generated PrintTicket.

On the other hand, in a case wherein the application 902 determines in step S2006 that the control is not for the final setting item, the application 902 returns to step S2001, obtains the control state of the next printing setting, and repeats this processing until the printing setting control for all of the setting items is completed.

Eventually, the state of the printing setting screen of the application is reflected on an argument pPrintTicket of the API shown in FIG. 6, and the PrintTicket such as shown in FIG. 11 is specified wherein a UI text string is described in the ReplaceDisplayString property.

Next, description will be made with reference to FIG. 12 regarding processing for displaying the printing setting screen on the printer driver 501 side after the property button 1207 being pressed in accordance with the user's operation.

A program of a new driver sub module (hereafter, referred to as “sub module”) making up the printer driver according to the present flow is stored in the external memory 11 of the computer, and is read into the RAM 2 and executed by the CPU 1.

The present processing corresponds to a part of a processing flow in a case wherein, with calling up of the Cn_DrvDocumentPropertySheets function shown in FIG. 5, display of the user interface is instructed as to the printer driver 501.

The instructions for display of the user interface are equivalent to a case wherein an fMode member of the CN_DOCUMENTPROPERTYHEADER structure shown in FIG. 6 is set to a DM_IN_PROMPT.

In step S2101, the sub module 502 receives a command corresponding to the display instructions of the printing setting screen in step S2007 by the application 902 shown in FIG. 10. Next, in step S2102, the sub module 502 obtains the PrintTicket specified in the pPrintTicket of the API shown in FIG. 6.

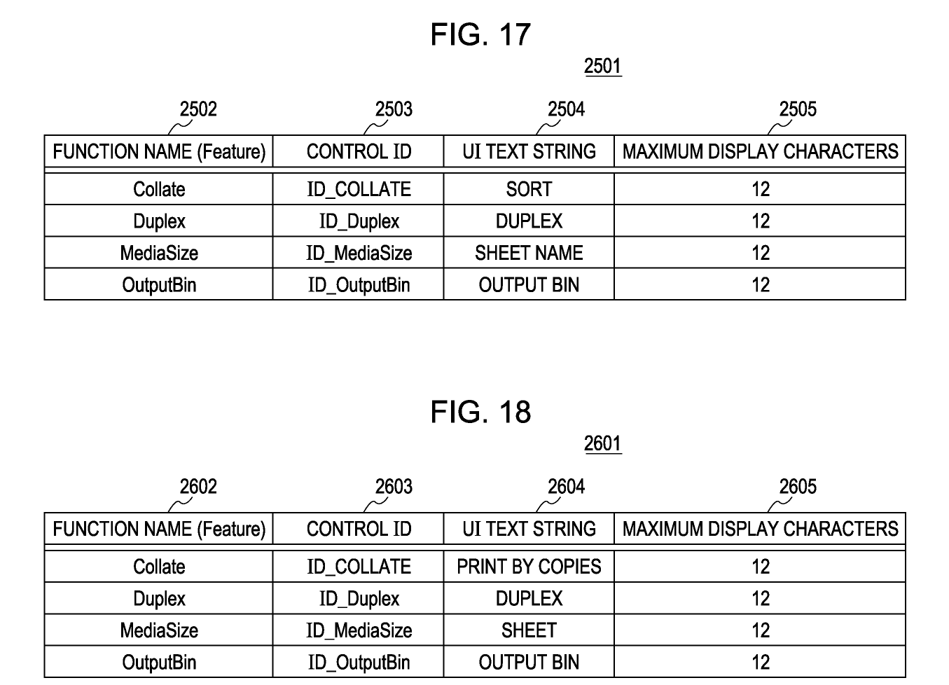

Next, in step S2103, the sub module 502 obtains text string table information 2501 held within the printer driver 501 such as shown in FIG. 17, and rasterizes this in the memory.

FIG. 17 is a diagram illustrating an example of the text string table information held within the printer driver 501 shown in FIG. 5. As shown in FIG. 17, a function name 2502, UI control ID 2503, UI text string 2504, and the number of the maximum UI display characters 2505 corresponding to the function thereof are stored in the text string table information in a correlated manner.

In step S2104, the sub module 502 references the first Feature within the PrintTicket obtained in step S2102, and in step S2105 determines whether or not the ReplaceDisplayString property exists within the referenced Feature. Here, in a case wherein the sub module 502 determines in step S2105 that the ReplaceDisplayString exists, the sub module 502 proceeds to step S2106. Subsequently, in step S2106 the sub module 502 searches the function name identical to the Feature currently referenced within the text string table information 2501 obtained in step S2103.

Next, in step S2107, the sub module 502 determines whether or not the identical function name exists in step S2106. Here, in a case wherein the sub module 502 determines that the identical function name exists, the sub module 502 proceeds to step S2108.

Subsequently, in step S2108, the sub module 502 replaces the UI text string 2503 of the identical function name with the ReplaceDisplayString text string within the specified PrintTicket.

On the other hand, in a case wherein the sub module 502 determines in step S2107 that no identical function name is searched, the sub module 502 proceeds to step S2109 without performing any more.

Subsequently, in step S2109, the sub module 502 determines whether or not the currently referenced Feature is the final Feature within the PrintTicket. Here, in a case wherein the sub module 502 determines that the currently referenced Feature is the final Feature, the sub module 502 proceeds to step S2111. Subsequently, in step S2111, the sub module 502 displays the UI screen of the printer driver on the display 10 in accordance with the UI text string 2204 of the text table information 2201 such as shown in FIG. 14, of which the UI text string has been replaced.

At this time, the text string of the control ID correlated with each function within the text string table information 2601 shown in FIG. 18 is replaced in accordance with the PrintTicket obtained from the application 902, and held in the sub module 502.

FIG. 18 is a diagram illustrating an example of the text string table information held by the printer driver 501 shown in FIG. 5. With the text string table information 2601 shown in FIG. 18, the UI text string (sort) 2604 of Collate which is a function name 2602 is replaced with “print by copies”, and the UI text string (sheet name) of MediaSize is replaced with “sheet”, which are each replaced with text strings specified by the application. Note that reference numeral 2603 denotes a control ID.

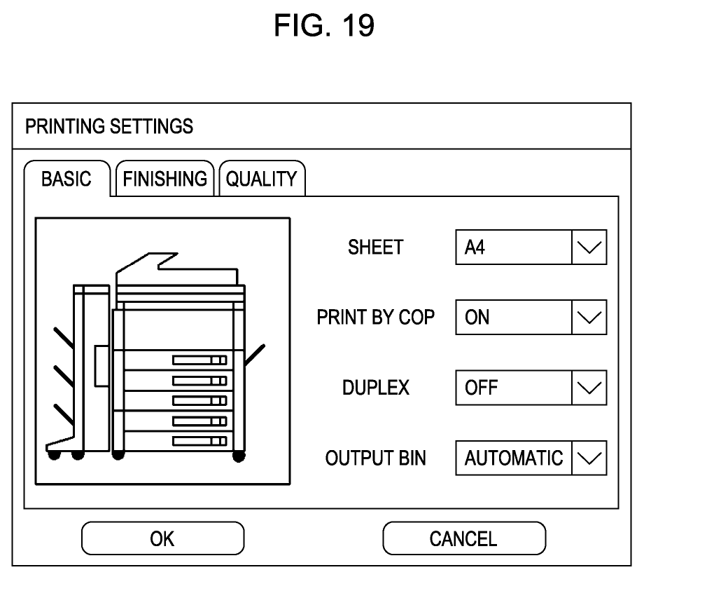

As a result thereof, the printing setting screen of the printer driver 501 which has been replaced with the text strings of the application 902 such as shown in FIG. 19 in accordance with the text string table information 2601 shown in FIG. 18 is displayed on the display 10.

Here, Characters exceeding the number of the maximum display characters 2605 set in the printing setting screen of the printer driver 501 are not displayed. That is to say, “print by copies” is made up of 15 characters, so just “print by cop”, equivalent to 12 characters, is displayed in accordance with the number of the maximum display characters “12”. Accordingly, the user may not recognize the item name thereof correctly at a glance in some cases.

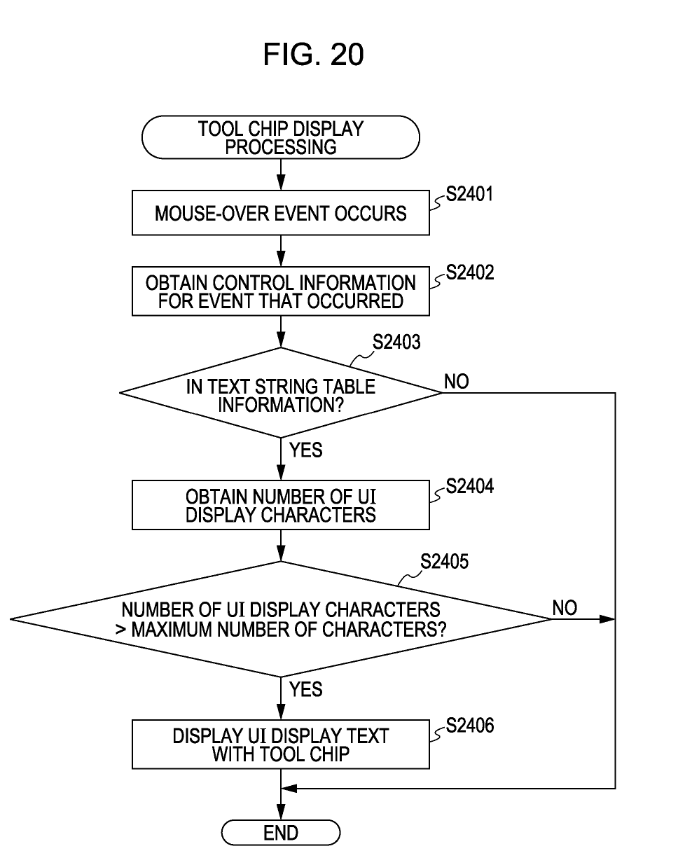

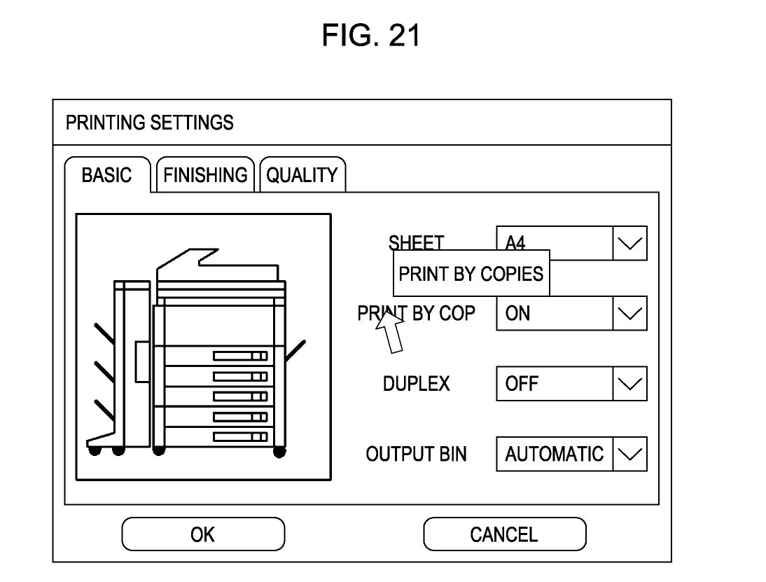

Therefore, hereafter, the printer driver 501 performs display processing shown in FIG. 20, thereby displaying all of the replaced text strings near the displayed item names such as shown in FIG. 21. Thus, all of the replaced text strings, and the text strings not displayed can be displayed in a face-to-face manner.

FIG. 20 is a flowchart illustrating an example of a fourth data processing procedure of the information processing device according to the present embodiment. The present example is a display processing example at the time of mouse-over as to control on the printing setting screen of the printer driver. Note that reference symbols S2401 through S2406 denote respective steps. Also, the respective steps are realized by the CPU 1 loading the printer driver 501 to the RAM 2 to execute this.

First, upon detecting that a mouse-over event has occurred in step S2401, in step S2402 the printer driver 501 obtains the control information of the UI wherein the event has occurred.

Next, in step S2403, the printer driver 501 determines whether or not the control ID of the control information obtained in step S2402 is included in the text string table information 2601 shown in FIG. 18.

In the case of determining that the control ID is included in the text string table information, in step S2404 the printer driver 501 obtains the number of the maximum display characters 2605 of the text string table information 2601 (content is 12).

On the other hand, in the case of determining in step S2403 that the control ID is not included in the text string table information, the printer driver 501 ends the present processing without performing any more.

Subsequently, in step S2405, the printer driver 501 compares the number of the maximum display characters 2605 corresponding to the relevant control, and the number of UI display characters of the UI text string 2604.

Subsequently, the printer driver 501 determines whether or not the number of UI display characters of the UI text string 2604 is greater than the number of the maximum display characters 2605. Here, in the case of determining that the number of UI display characters of the UI text string 2604 is greater than the number of the maximum display characters 2605, the printer driver 501 proceeds to step S2406.

Specifically, the printer driver 501 determines that the number of UI display characters of the UI text string 2604 exceeds the number of the maximum display characters 2605 since the “print by copies” which is a UI text string is made up of 15 characters.

Subsequently, in step S2406, the printer driver 501 performs display control so as to make a pop up display of “print by copies” having 15 characters in total which is the entire text string of the UI text string 2604 near the replaced text string “print by cop” by employing a tool chip, and ends the present processing on the display 10. Note that the present example shows a case wherein the language is English, but the language of a text string to be displayed, the number of characters thereof, and display mode, are not restricted to the present embodiment, and may be changed depending on the location of implementation.

FIG. 21 is a diagram illustrating an example of the user interface displayed on the display 10 shown in FIG. 1. The present example is a printing setting screen example wherein a UI text string replaced at the printer driver 501 is displayed by the tool chip. As shown in FIG. 21, with the present embodiment, the entire display of the “print by copies” which is cut at the 12'th character is displayed by the tool chip.

On the other hand, in the case of determining that the UI text string 2604 is smaller than the number of the maximum display characters 2605, the printer driver 501 ends the present processing without performing any more.

According to the above-mentioned procedure, when a UI text string of the printer driver is replaced with a UI text string of the application, even in a case wherein the above-mentioned text string display is cut in the middle thereof, the entire replaced text string can be displayed. Thus, the user performs operations for instructing a text string, whereby the user can confirm the content of the function text string thereof.

Description will be made below regarding a display flow of the printing setting screen of the application, and a display flow of the printing setting screen of the printer driver using the interface functions shown in FIGS. 5 and 6.

The present embodiment is an example wherein, when a UI text string of the printer driver 501 is replaced with a UI text string of the application 902, the original UI text string and replaced text string of the printer driver are displayed simultaneously.

FIG. 7B illustrates a flow at the time of displaying the printing setting screen managed by the application 902 itself. Note that the program of the application 902 is stored in the external memory 11 of the computer, and is read into the RAM 2 and executed by the CPU 1.

In step S1901, the application 902 obtains the PrintCapabilities through the print ticket API 505 to obtain the capability information of the printer device. Specifically, the application 902 obtains the PrintCapabilities in an XML format such as shown in FIG. 32 from the printer driver 501. Four Features of Collate, Duplex, MediaSize, and OutputBin are included in the PrintCapabilities shown in the example in FIG. 32. A DisplayName property is specified as to each of the Features.

Subsequently, in step S1902 shown in FIG. 7B, the application 902 obtains a function name and the text string table information 1501 of the UI corresponding thereto, such as shown in FIG. 8. As shown in FIG. 8, a UI text string 1503, and a UI control ID 1504, corresponding to a function name 1502 are stored in the text string table information 1501.

Subsequently, in step S1903, the application 902 references the text string table information 1501 obtained in step S1902 to obtain the first function information.

Next, in step S1904, the application 902 determines whether or not the function obtained from the text string table information 1501 in step S1903 is a function included in the PrintCapabilities obtained from the printer driver 501 in step S1901.

Here, in a case wherein the application 902 determines that the function obtained in step S1903 is included in the PrintCapabilities obtained from the printer driver 501, the application 902 proceeds to step S1905. Subsequently, in step S1905, the application 902 employs the text string corresponding to a Feature name stored in the text string table information 1501 to display the application UI on the display 10.

Next, in step S1906, the application 902 determines whether or not the currently obtained function information is the final item of the text string table information 1501, and in the case of determining that the obtained function information is the final item, the application 902 ends the present processing.

On the other hand, in a case wherein the application 902 determines in step S1906 that the currently obtained function information is not the final item, the application 902 proceeds to step S1908, obtains the next item within the text string table information 1501, and then repeats the processing in steps S1904 through S1906.

On the other hand, in a case wherein the application 902 determines in step S1904 that the function obtained in step S1903 is not included in the PrintCapabilities obtained from the printer driver 501 in step S1901, the application 902 proceeds to step S1907. Subsequently, in step S1907, the application 902 displays the UI control corresponding to the function thereof on the UI screen grayed out (indicated with shading in the drawing), and informs the user as an unavailable function.

FIG. 9 is the printing setting screen 1201 of the application made up of the display control processing shown in FIG. 7. In FIG. 9, sheet setting control 1202, duplex setting control 1203, and print by copies setting control 1205 are displayed with the UI text strings within the text string table information 1501, respectively. Also, the staple setting control 1206 not included in the PrintCapabilities obtained from the printer driver 501 is grayed out.

The printing setting screen 1201 of the application further includes a printer selection control 1204 for selecting a printer, and a property button 1207 for displaying the printing setting screen of the printer driver. Further, the printing setting screen 1201 of the application is configured so as to include an OK button 1208 for determining the printing setting screen, and a cancel button 1209.

Next, description will be made regarding processing wherein the property button 1207 of the printing setting screen 1201 of the application is pressed, and display of the printing setting screen of the printer driver is instructed from the application 902.

FIG. 10 is a processing flow wherein, when the property button 1207 of the application 902 is pressed, instructions for displaying the printing setting screen of the printer driver 501 are performed from the application 902.

Note that the program of the application 902 according to the present flow is stored in the external memory of the computer, and is read into the RAM 2 and executed by the CPU 1.

In step S2001, the application 902 obtains the selection state of control relating to the printing settings within the printing setting screen 1201. Next, in step S2002, the application 902 references the Feature corresponding to the control of which the state has been obtained in step S2001, of the Feature list within the PrintCapabilities obtained from the printer driver 501 in step S1901 shown in FIG. 7.

Next, in step S2003, the application 902 eliminates Options other than the items corresponding to the setting items in a selected state, of the Option list of the referenced Feature.

As a result thereof, as shown in FIG. 11, the application 902 generates a PrintTicket 1401 in a state wherein only the Option of a particular setting item is described in the Feature.

The example shown in FIG. 11 is an example wherein “On” Option is selected for a “Collate” Feature, and “OFF” Option is selected for a “Duplex” Feature, respectively.

Next, in step S2004, the application 902 obtains the text string table information 1501. Subsequently, in step S2005, the application 902 references the text string table information 1501 to obtain the text string information of a function relating to the current control, and specifies this in the PrintTicket 1401 as a ReplaceDisplayString property.

With the example in FIG. 11, “print by copies” which is a text string corresponding to the Collate within the text string table information 1501 of the application is described as a ReplaceDisplayString property of the “Collate” Feature.

Next, in step S2006, the application 902 determines whether or not the printing setting control referenced in step S2001 is for the final setting item. Here, in the case of the application 902 determining that the control is for the final setting item, the application 902 proceeds to step S2007. Subsequently, in step S2007, the application 902 instructs the API for instructions for displaying the printing setting screen of the printer driver shown in FIG. 6 to display of the printing setting screen of the printer driver 501 by specifying the generated PrintTicket.

On the other hand, in a case wherein the application 902 determines in step S2006 that the control is not for the final setting item, the application 902 returns to step S2001, obtains the control state of the next printing setting, and repeats this processing until the printing setting control for all of the setting items is completed.

Eventually, the state of the printing setting screen of the application is reflected on an argument pPrintTicket of the API shown in FIG. 6, and the PrintTicket such as shown in FIG. 11 is specified wherein a UI text string is described in the ReplaceDisplayString property.

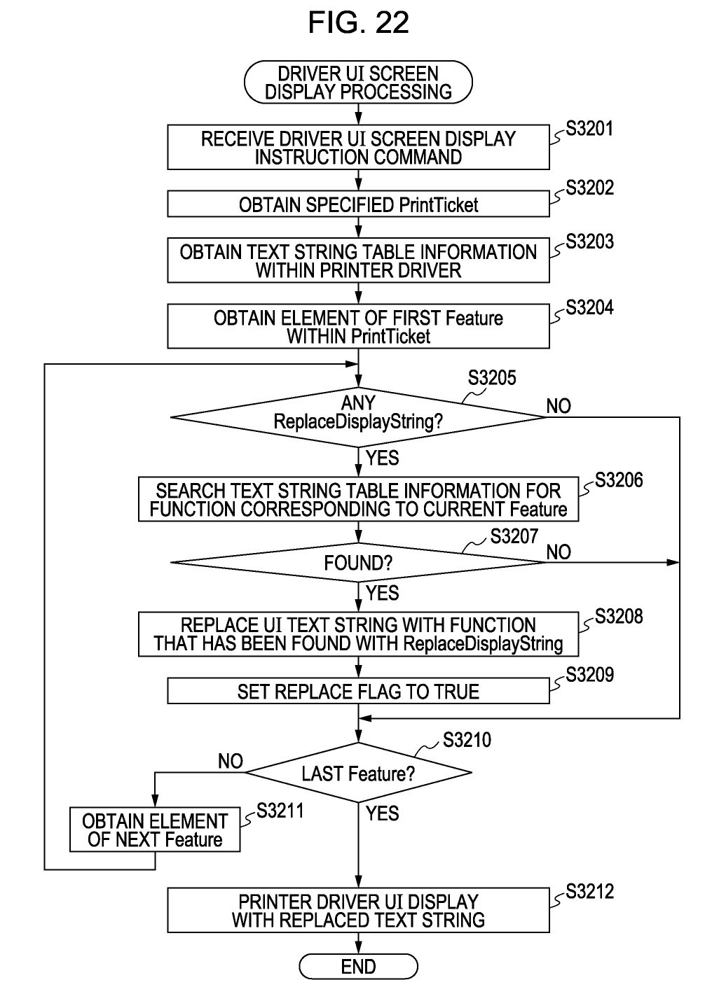

FIG. 22 is a flowchart illustrating an example of a fifth data processing procedure of the information processing device according to the present embodiment. The present example is a processing example for displaying the printing setting screen on the printer driver 501 side after the property button 1207 shown in FIG. 9 is pressed.

More specifically, the present processing corresponds to a part of a processing flow in a case wherein, with calling up of the Cn_DrvDocumentPropertySheets function shown in FIG. 5, display of the user interface is instructed as to the printer driver 501.

Also, the instructions for display of the user interface are equivalent to a case wherein an fMode member of the CN_DOCUMENTPROPERTYHEADER structure shown in FIG. 6 is set to a DM_IN_PROMPT.

Note that reference symbols S3201 through S3212 are respective steps. Also, the program of the sub module 502 relating to the respective steps is stored in the external memory 11 of the computer, and is read into the RAM 2 and executed by the CPU 1.

In step S3201, the sub module 502 receives a command on the printer driver side, which corresponds to instructions for displaying the printing setting screen in step S2007. In step S3202, the sub module 502 obtains the PrintTicket specified in the pPrintTicket of the API shown in FIG. 6 from the application 902.

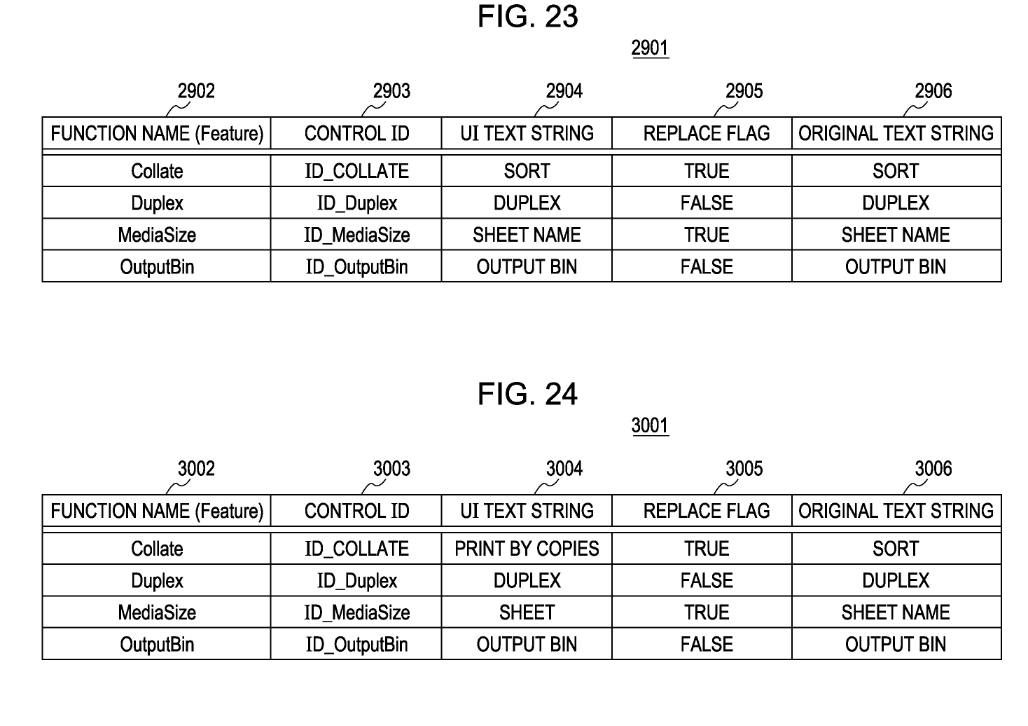

Next, in step S3203, the sub module 502 obtains text string table information 2901 held within the printer driver such as shown in FIG. 23, and rasterizes this in the RAM 2.

FIGS. 23 and 24 are diagrams illustrating an example of the text string table information held within the printer driver of the information processing device according to the present embodiment.

A function name 2902, and UI control ID 2903, UI text string 2904, replace flag 2905, and original text string 2906 corresponding to the function thereof are stored in the text string table information 2901 shown in FIG. 23 in a correlated manner.

Next, in step S3204, the sub module 502 references the first Feature within the PrintTicket obtained from the application 902 in step S3202, and in step S3205 determines whether or not the ReplaceDisplayString property exists within the referenced Feature.

Here, in a case wherein the sub module 502 determines that the ReplaceDisplayString exists, the sub module 502 proceeds to step S3206. Subsequently, in step S3206, the sub module 502 searches the function name identical to the Feature currently referenced within the text string table information 1601 obtained in step S3203.

Next, in step S3207, the sub module 502 determines whether or not the identical function name exists by the search in step S3206. Here, in a case wherein the sub module 502 determines that the identical function name exists, the sub module 502 proceeds to step S3208. Subsequently, in step S3208, the sub module 502 replaces the UI text string 2903 of the identical function name with the ReplaceDisplayString text string within the specified PrintTicket.

On the other hand, in a case wherein the sub module 502 determines in step S3207 that no identical function name has been searched, the sub module 502 proceeds to step S3210 without performing any more.

Next, in step S3209, the sub module 502 sets the replace flag 2905 shown in FIG. 23 to TRUE indicating that the a UI text string has been replaced. Next, in step S3210, the sub module 502 determines whether or not the currently referenced Feature is the final Feature within the PrintTicket. In a case wherein the sub module 502 determines that the currently referenced Feature is not the final Feature, in step S3211 the sub module 502 references the next Feature and proceeds to step S3205 discussed above. On the other hand, in a case wherein the sub module 502 determines that the currently referenced Feature is the final Feature, the sub module 502 proceeds to step S3212. Subsequently, in step S3212, the sub module 502 displays the UI screen on the display 10 in accordance with the UI text string 3004 of the text table information 3001 such as shown in FIG. 24, of which the UI text string has been replaced.

At this time, the sub module 502 replaces the text string of the control ID correlated with each function within the text string table information 3001.

With the text string table information 3001 shown in FIG. 24, the UI text string (sort) 3004 of Collate which is a function name 3002 is replaced with “print by copies”, and the UI text string (sheet name) of MediaSize is replaced with “sheet”, which are each replaced with text strings specified by the application. Note that, in FIG. 24, reference numeral 3003 denotes a control ID, 3005 denotes a replace flag, and 3006 denotes an original text string.

As a result thereof, the sub module 502 displays the printing setting screen which has been replaced with the text strings of the application, such as shown in the user interface of FIG. 19, on the display 10.

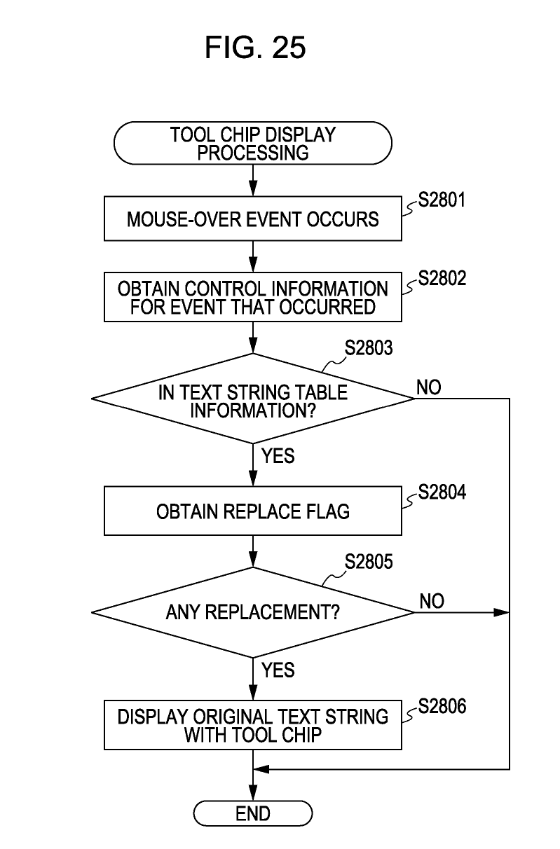

FIG. 25 is a flowchart illustrating an example of a fifth data processing procedure of the information processing device according to the present embodiment. The present example is a processing example at the time of mouse-over as to control on the printing setting screen of the sub module 502. Note that reference symbols S2801 through S2806 denote respective steps, and the program of the sub module 502 relating to the respective steps is stored in the external memory 11 of the computer, and is read into the RAM 2 and executed by the CPU 1.

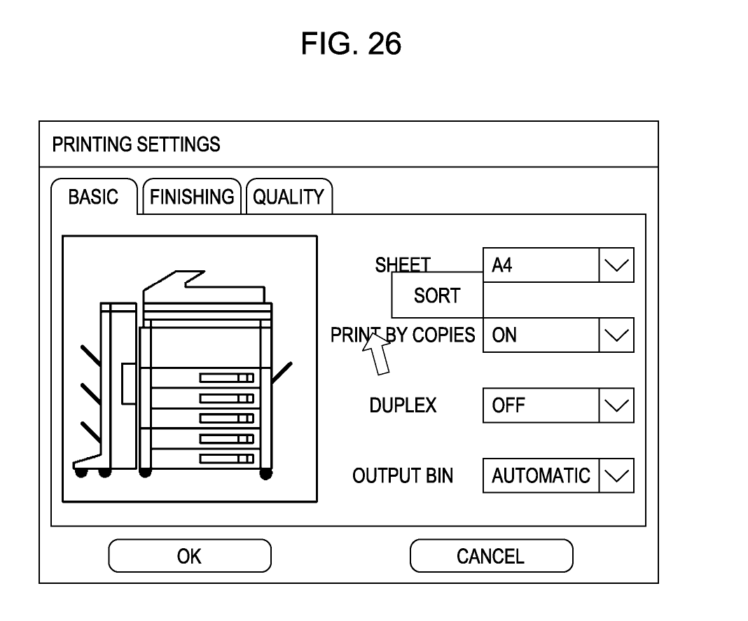

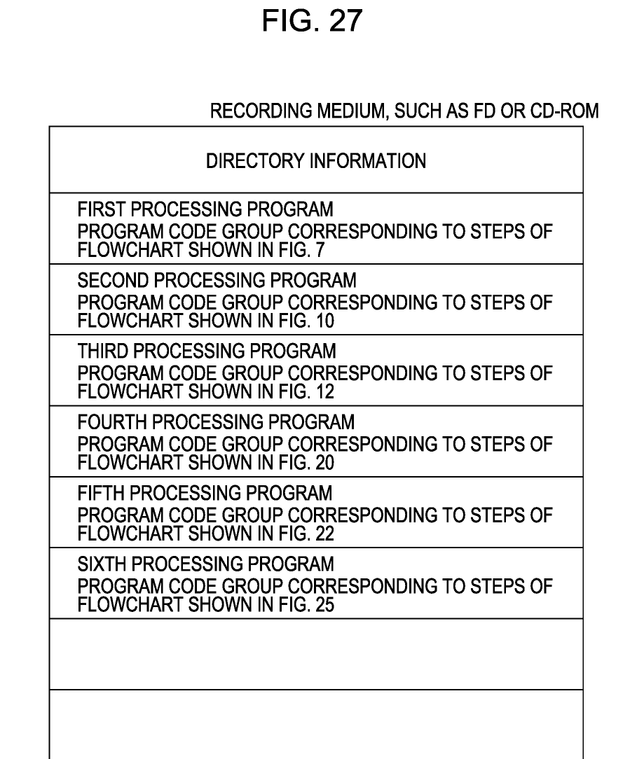

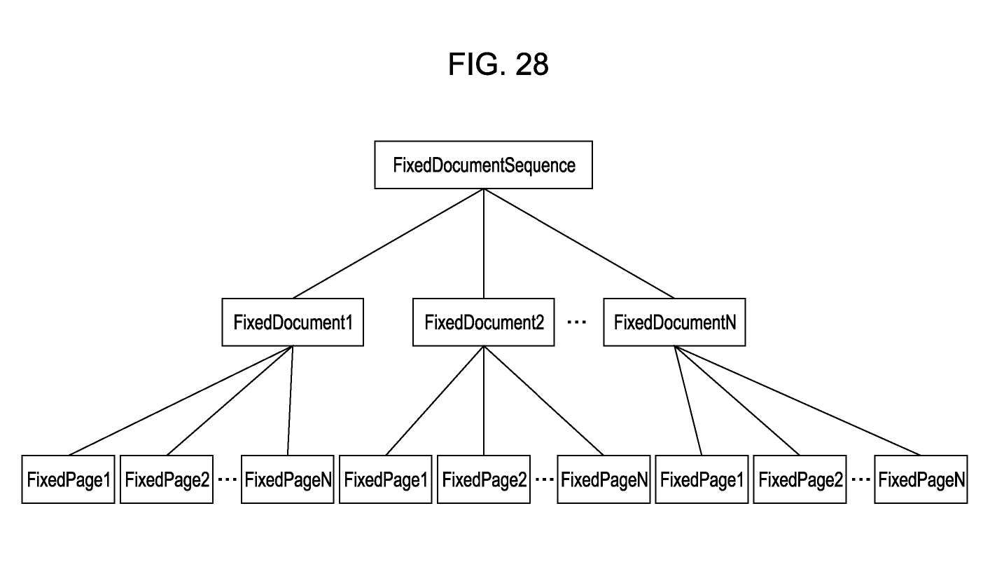

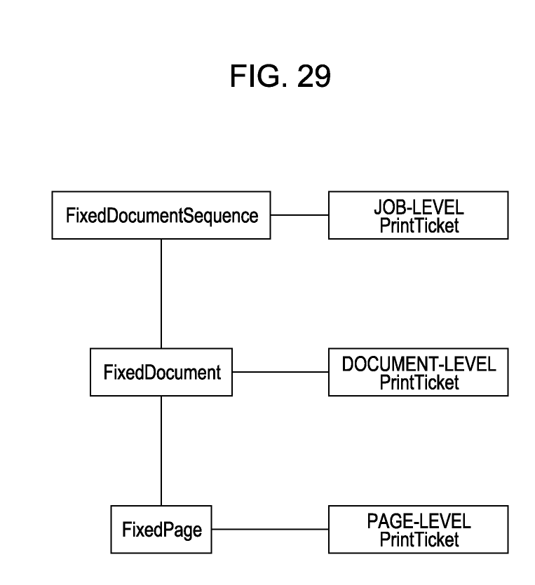

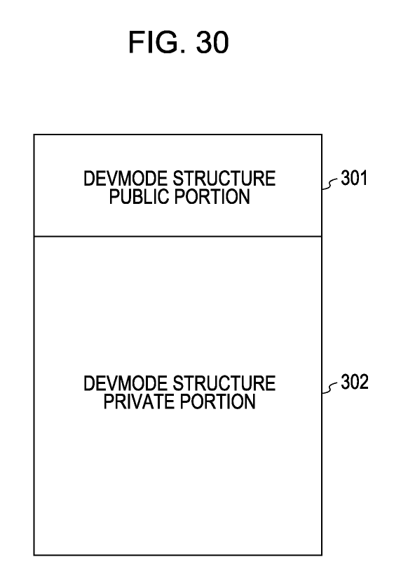

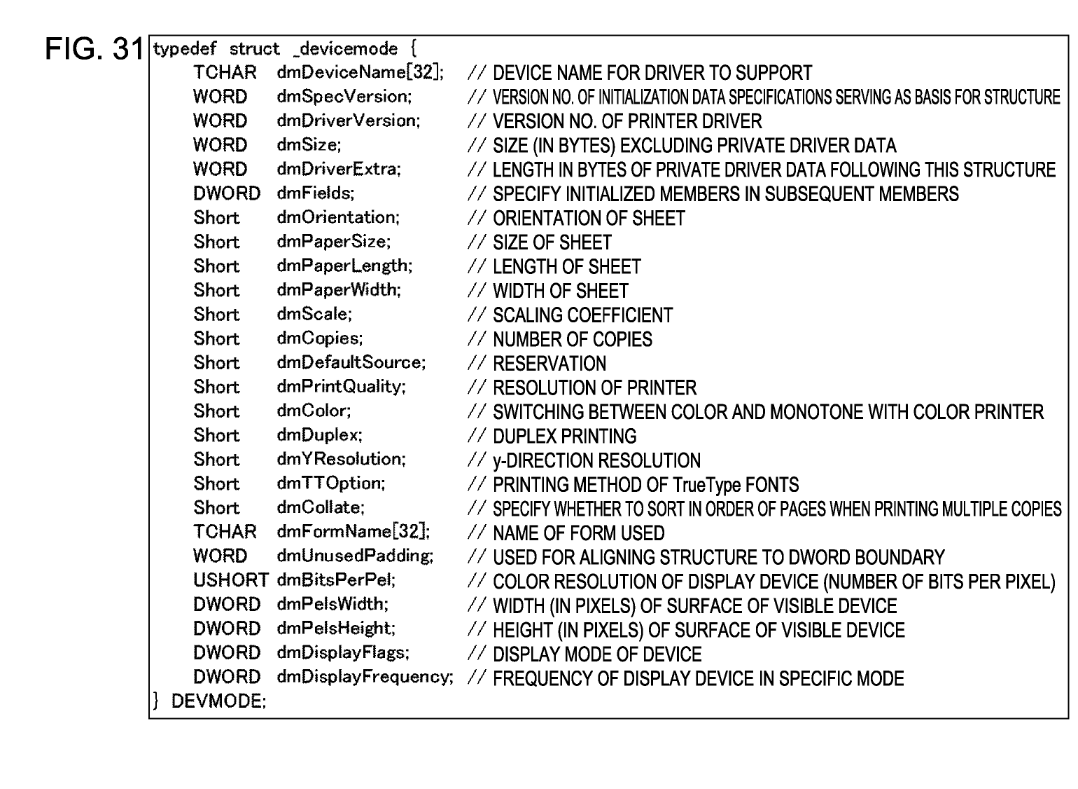

First, in response to the pointing device being operated by the user, as shown in FIG. 26, upon detecting that a mouse-over event wherein the mouse is moved has occurred in step S2801, the sub module 502 proceeds to step S2802.

Subsequently, in step S2802, the sub module 502 obtains the control information of the UI wherein the mouse-over event has occurred. Here, information indicating a function such as shown in FIG. 26, e.g., in the case of detecting that the mouse has moved near “sheet”, “collate” is obtained.

Next, in step S2803, the sub module 502 determines whether or not the control ID of the control information obtained in step S2802 is included in the text string table information 3001. Here, in the case of determining in step S2803 that the control ID is included in the text string table information, in step S2804 the sub module 502 obtains the replace flag 2905 of the text string table information 3001.

On the other hand, in the case of determining in step S2803 that the control ID is not included in the text string table information 3001, the sub module 502 ends the present processing without performing any more.

Next, in step S2805, the sub module 502 references the replace flag 3005 of the text string table information 3001 to determine whether or not the replaced text string is TRUE. Here, in the case of determining that the replace flag 3005 is TRUE, in step S2806 the sub module 502 displays the original text string 3005 of the relevant control on the display 10 by employing the tool chip.

FIG. 26 is a diagram illustrating an example of the user interface displayed on the display 10 shown in FIG. 1. The present example is a printing setting screen example of the printer driver.

As shown in FIG. 26, with the present embodiment, the UI text string (print by copies) replaced at the application 902, and the original text string (sort) of the printer driver 501 are displayed together on the same UI screen by the tool chip. Moreover, the “print by copies” and “sort” are displayed in a state keeping the adjacent position relation between both. Thus, the user can visually recognize states before and after a text string is replaced on the driver UI screen only by performing simple operations.

On the other hand, in the case of determining that the replace flag 3005 is FALSE, the sub module 502 ends the present processing without performing any more.

According to the above-mentioned procedure, when a UI text string of the printer driver is replaced with a UI text string of the application, the original UI text string of the printer driver can be displayed simultaneously.

Note that an arrangement may be made wherein a mode for activating display control according to some embodiments, and a mode for activating display control according to some embodiments are provided, and the display control of a text string is switched according to a default setting mode.

Also, an arrangement may be made wherein the user can switch the display control of a function text string from the display control shown in an embodiment above to the display control shown in an embodiment above by performing operations of a command key or the like. At this time, with regard to which display control is prioritized, let us say that switching is performed from display control determined at a default setting to another display control.

Description will be made below regarding the structure of a data processing program which can be read by the information processing device according to the present invention with reference to the memory map shown in FIG. 27.

FIG. 27 is a diagram for describing the memory map of a computer-readable storage medium in which various types of data processing program which can be read by the information processing device according to the present invention are stored.

Note that, though not particularly shown in the drawing, information managing a program group stored in a computer-readable storage medium, e.g., version information, producer, and so forth are stored, and also information depending on the OS or the like on the program readout side, e.g., an icon or the like identifying and displaying a program are stored in some cases.

Further, data belonging to various types of program is also managed with the above-mentioned directory. Also, in a case wherein a program for installing various types of program in the computer, or a program to be installed is compressed, a decompressing program or the like is also stored in some cases.

The functions shown in FIGS. 7B, 10, 12, 20, 22, and 25 according to the present embodiment may be executed by the host computer through a program to be installed externally. Subsequently, in this case, the present invention is applied to even a case wherein an information group including the program is supplied to an output device from a computer-readable storage medium such as CD-ROM, flash memory, FD, or the like, or an external computer-readable storage medium through a network.

As described above, it goes without saying that the functions of the present invention can also be provided with an arrangement wherein a computer-readable storage medium in which software program code for realizing the functions of the above-mentioned embodiments is recorded is supplied to a system or device, and subsequently, the computer (or CPU or MPU) of the system or device thereof reads out and executes the program code stored in the computer-readable storage medium.

In this case, the program code itself read out from the computer-readable storage medium realizes a new function of the present invention, and accordingly, the computer-readable storage medium storing the program code thereof makes up the present invention. Accordingly, any program form may be employed, such as object code, program executed by an interpreter, script data to be supplied to the OS, or the like, as long as it includes program functions.

Examples which may be employed as the computer-readable storage medium for supplying the program include a flexible disk, hard disk, optical disc, magneto-optical disk, MO, CD-ROM, CD-R, CD-RW, magnetic tape, nonvolatile memory card, ROM, and DVD.

In this case, the program code itself read out from the computer-readable storage medium realizes the functions of the above-described embodiments, and accordingly, the computer-readable storage medium storing the program code thereof makes up the present invention.

Additionally, as for a program supplying method, the computer program according to the present invention can be supplied by employing a browser of a client computer to connect to a homepage of the Internet, and downloading the computer program according to the present invention from the relevant home page, or downloading a file including a compressed automatic installation function into a computer-readable storage medium such as a hard disk or the like. Also, the program according to the present invention can also be supplied by dividing the program code making up the program according to the present invention into multiple files, and downloading each file from a different home page. That is to say, a WWW server, ftp server, and so forth for allowing multiple users to download a program file for realizing the function processing according to the present invention at a computer are also encompassed in the Claims of the present invention.

Also, an arrangement may be made wherein the program according to the present invention is encrypted and stored in a computer-readable storage medium such as CD-ROM or the like, and is distributed to users, and a user satisfying predetermined conditions is allowed to download key information for decryption from a home page through the Internet. Subsequently, the user employs the key information thereof to execute the encrypted program to download this in the user's computer, thereby realizing the functions of the above-mentioned embodiments.

Also, the present invention is not restricted to a case wherein the functions of the above-mentioned embodiments are realized by the computer executing the read program code. It goes without saying that the present invention also includes, for example, a case wherein the OS (Operating System) or the like running on the computer executes a part or all of the actual processing based on the instructions of the program code thereof, and the functions of the above-mentioned embodiments are realized by the processing thereof.

Further, it goes without saying that the present invention also includes a case wherein the program code read out from a computer-readable storage medium is written in the memory included in a function expansion board inserted in the computer or function expansion unit connected to the computer, and subsequently, the CPU or the like included in the function expansion board or function expansion unit executes a part or all of the actual processing based on the instructions of the program code thereof, and the functions of the above-mentioned embodiments are realized by the processing thereof.

The present invention is not restricted to the above-mentioned embodiments, and various modifications and changes (including an organic combination of the respective embodiments) can be made, and these are not excluded from the scope of the present invention.

While various examples and embodiments of the present invention have been described, it can be clearly understood by one skilled in the art that the essence and scope of the present invention are not restricted to specific descriptions within the present Specification.

According to an embodiment of the present invention, characters to be displayed by a function of a printer driver can be displayed so as to correspond to characters to be displayed by a function of an application.

While the present invention has been described with reference to exemplary embodiments, it is to be understood that the invention is not limited to the disclosed exemplary embodiments. The scope of the following claims is to be accorded the broadest interpretation so as to encompass all modifications, equivalent structures and functions.

This application claims the benefit of Japanese Application No. 2007-277906 filed Oct. 25, 2007, which is hereby incorporated by reference herein in its entirety.

What is claimed is:

1. An information processing device comprising:
a first obtaining unit configured to obtain printer capability information from a printer driver;
a second obtaining unit configured to obtain text string information corresponding to a function based on the printer capability information obtained from said first obtaining unit; and
an instructing unit configured to perform instructions for displaying characters of the function displayed on a printer driver screen using characters of the text string information obtained by said second obtaining unit.

2. An information processing device comprising:
an output unit configured to output printer capability information to an application;
a reception unit configured to receive instructions from an application for displaying characters of a function displayed on a printer driver screen using text string information corresponding to the function obtained based on the printer capability information output to the application by said output unit; and
a display unit configured to display the characters of the function displayed on the printer driver screen based on the instructions received by said reception unit.

3. The information processing device according to claim 2, wherein said display unit does not display a text string exceeding a predetermined number of maximum display characters of a text string for displaying a function.

4. The information processing device according to claim 3, further comprising:
a determining unit configured to determine, in response to the text string indicating the function displayed by said display unit being instructed by a user's operations, whether or not the number of characters of the instructed text string exceeds the number of the maximum display characters;
wherein said display unit displays all of the text string including a text string not displayed in a case wherein said determining unit determines that the number of characters of the instructed text string exceeds the number of the maximum display characters.

5. The information processing device according to claim 4, wherein said display unit displays both of a text string not displayed by exceeding said number of the maximum display characters, and said all of the text string.

6. The information processing device according to claim 2, further comprising:
a determining unit configured to determine, in response to a text string indicating the function displayed by said display unit being instructed by a user's operations, whether or not the characters of the function displayed on the printer driver screen have been replaced;
wherein said display unit displays both of the characters of the function displayed on the screen based on the instructions received by said reception unit, and the characters of the function displayed on the printer driver screen in a case wherein said determining unit determines that the characters of the function displayed on the printer driver screen have been replaced.

7. An information processing method comprising:
obtaining printer capability information from a printer driver;
obtaining text string information corresponding to a function based on the printer capability information; and
performing instructions for displaying characters of the function displayed on a printer driver screen using characters of the text string information.

8. An information processing method comprising:
outputting printer capability information to an application;
receiving instructions from an application for displaying characters of a function displayed on a printer driver screen using text string information corresponding to the function obtained based on the printer capability information output to the application; and
displaying the characters of the function displayed on the printer driver screen based on the instructions received.

9. The information processing method according to claim 8, wherein said displaying comprises not displaying a text string exceeding a predetermined number of maximum display characters of a text string for displaying a function.

10. The information processing method according to claim 9, further comprising:
determining, in response to the text string indicating the function displayed by said displaying being instructed by a user's operations, whether or not the number of characters of the instructed text string exceeds the number of the maximum display characters;
wherein said displaying comprises displaying all of the text string including a text string not displayed in a case wherein said determining determines that the number of characters of the instructed text string exceeds the number of the maximum display characters.

11. The information processing method according to claim 10, wherein said displaying comprises displaying both of a text string not displayed by exceeding said number of the maximum display characters, and said all of the text string.

12. The information processing method according to claim 8, further comprising:
determining, in response to a text string indicating the function displayed by said displaying being instructed by a user's operations, whether or not the characters of the function displayed on the printer driver screen have been replaced;
wherein said displaying comprises displaying both of the characters of the function displayed on the screen based on the instructions received, and the characters of the function displayed on the printer driver screen in a case wherein said determining determines that the characters of the function displayed on the printer driver screen have been replaced.

13. A computer-readable storage medium storing a program configured to execute a method comprising:
obtaining printer capability information from a printer driver;
obtaining text string information corresponding to a function based on the printer capability information; and
performing instructions for displaying characters of the function displayed on a printer driver screen using characters of the text string information.

14. A computer-readable storage medium storing a program configured to execute a method comprising:
outputting printer capability information to an application;
receiving instructions from an application for displaying characters of a function displayed on a printer driver screen using text string information corresponding to the function obtained based on the printer capability information output to the application; and
displaying the characters of the function displayed on the printer driver screen based on the instructions received.

15. The computer-readable storage medium according to claim 14, wherein said displaying comprises not displaying a text string exceeding a predetermined number of maximum display characters of a text string for displaying a function.

16. The computer-readable storage medium according to claim 15, further comprising:
determining, in response to the text string indicating the function displayed by said displaying being instructed by a user's operations, whether or not the number of characters of the instructed text string exceeds the number of the maximum display characters;
wherein said displaying comprises displaying all of the text string including a text string not displayed in a case wherein said determining determines that the number of characters of the instructed text string exceeds the number of the maximum display characters.

17. The computer-readable storage medium according to claim 16, wherein said displaying comprises displaying both of a text string not displayed by exceeding said number of the maximum display characters, and said all of the text string.

18. The computer-readable storage medium according to claim 14, further comprising:
determining, in response to a text string indicating the function displayed by said displaying being instructed by a user's operations, whether or not the characters of the function displayed on the printer driver screen have been replaced;
wherein said displaying comprises displaying both of the characters of the function displayed on the screen based on the instructions received, and the characters of the function displayed on the printer driver screen in a case wherein said determining determines that the characters of the function displayed on the printer driver screen have been replaced.
